(19) United States
(12) Patent Application Publication
(10) Pub. No.: US 2026/0042975 A1
(43) Pub. Date: Feb. 12, 2026

(54) Multifunctional Constructive Wax Assembly

(71) Applicants: Ryan Chickos, Bella Vista, AR (US); Chelsea Halonen, Bella Vista, AR (US)

(72) Inventors: Ryan Chickos, Bella Vista, AR (US); Chelsea Halonen, Bella Vista, AR (US)

(21) Appl. No.: 19/290,839

(22) Filed: Aug. 5, 2025

Related U.S. Application Data
(60) Provisional application No. 63/681,994, filed on Aug. 12, 2024.

(51) Int. Cl. C11C 5/00

(52) U.S. Cl. CPC C11C 5/008; C11C 5/002

(57) ABSTRACT

A customizable wax assembly comprising either interlocking Modular Candle Elements or a single-body Infuser-Compatible Candle structure, each configured to form three-dimensional candle assemblies. The Modular Candle Elements may define flat, angled, curved, or irregular outer profiles and are configured to engage with adjacent elements to form complete geometric, symbolic, or ornamental shapes, including but not limited to cylinders, hearts, pyramids, and other seasonally themed or user-customized configurations. One or more components may include cavities for receiving wicks and elongated Fragrance Elements positioned to extend from a Wick Zone inward or outward across a Thermally Active Zone, to promote early-stage and sustained fragrance release during combustion. Optional Assembly Keys may be incorporated to enhance structural stability and enable complex design patterns.

### FIELD OF THE INVENTION

The present invention relates generally to candles, and more specifically to customizable candle systems composed of modular interlocking wax-based elements or unitary wax-based candle bodies. The invention further relates to wax components that may incorporate fragrance cavities, wick channels, interlocking geometries, and decorative features for configurable assembly and scent distribution.

### BACKGROUND OF THE INVENTION

Conventional candles provide limited user customization, being manufactured with fixed geometric profiles, colorants, and fragrance compositions. While certain DIY candle-making kits allow for some personalization, they often require molds, heating tools, or processes that are inaccessible to the average consumer. In traditional candles, fragrance is statically embedded within the wax matrix and cannot be reconfigured after manufacture. These limitations restrict end-user creative control, reduce product modularity, and increase manufacturing complexity when offering varied product lines. Accordingly, there exists a need for a candle system that enables user-directed customization of both visual and aromatic attributes, supports modular and standalone embodiments, and decouples fragrance delivery from wax composition without compromising safety, combustion performance, or manufacturability.

### BRIEF SUMMARY OF THE INVENTION

The present invention provides a customizable wax assembly comprising one or more Modular Candle Elements configured to interlock with adjacent elements to form a three-dimensional candle structure. Each Modular Candle Element may include flat, angled, curved, irregular, or ornamental outer perimeters and may be formed with complementary interlocking geometries. Modular Candle Elements may vary in height, color, or surface contour to support visual customization, assembly difficulty, or thematic design. When assembled, the elements define an integrated candle body with a geometric or decorative external profile.

In certain embodiments, Modular Candle Elements include one or more cavities dimensioned to receive a Fragrance Element, a wick, or an optional Assembly Key. The Fragrance Elements may comprise elongated solid bodies formed of wax or compatible fragrance-infused material and are positioned relative to the wick such that at least a portion of the Fragrance Element resides within a thermal activation zone during combustion. This configuration facilitates tiered or sustained fragrance release based on burn progression and element position. Cavities may be oriented vertically, horizontally, or at an angle, and may align across adjacent Modular Candle Elements to define continuous or intersecting channels for receiving wicks, Fragrance Elements, or structural Assembly Keys that promote alignment, interlock retention, or assembly complexity.

The invention further includes an Infuser-Compatible Candle formed as a single, non-modular structure with preformed cavities dimensioned to receive Fragrance Elements. This embodiment enables user-selected fragrance configurations without requiring modular assembly, addressing limitations of traditional candles that rely solely on pre-fragranced wax. Additional embodiments may include decorative geometries or fragrance-blending kits. The invention includes modular and non-modular candle embodiments, each enabling structural and aromatic customization through interchangeable or embedded Fragrance Elements.

### BRIEF DESCRIPTION OF DRAWINGS

FIG. 1 is a top-down view of a single Modular Candle Element showing an exemplary interlocking profile, outer perimeter shape, and partial cavities that align with corresponding cavities in adjacent Modular Candle Elements to form channels for receiving Fragrance Elements and wick components.

FIG. 2 is a perspective view of the Modular Candle Element of FIG. 1, depicting its three-dimensional structure and exemplary interlocking geometry.

FIG. 3 is a top-down view of a fully assembled configuration comprising four identical Modular Candle Elements, each having the same profile as the element shown in FIG. 1, arranged in a repeating circular perimeter pattern about a central axis. The figure illustrates how partial cavities within each element align upon assembly to define continuous vertical channels for receiving a wick and multiple Fragrance Elements. Four Fragrance Elements and one wick are shown installed within the assembled structure.

FIG. 4 is a perspective partially exploded view of the square-profile configuration shown in FIG. 3, comprising four identical Modular Candle Elements arranged in a repeating circular perimeter pattern about a central axis and separated to illustrate directional assembly. The Modular Candle Elements vary in height, demonstrating how the interlocking geometry accommodates uneven segments. One wick and three of four Fragrance Elements are shown installed; the fourth Fragrance Element is omitted for visual clarity. A directional arrow labeled (A1) indicates the intended insertion path for the Modular Candle Elements during assembly.

FIG. 5 is a perspective view of the fully assembled configuration shown in FIG. 4. The structure exhibits a square-profile configuration in this embodiment. All Fragrance Elements and the central wick are shown installed.

FIG. 6 is a perspective view of a cylindrical Fragrance Element.

FIG. 7 is a profile view of the Fragrance Element depicted in FIG. 6, illustrating its cross-sectional geometry.

FIG. 8 is a profile view of a Fragrance Element with a slot-shaped cross-section.

FIG. 9 is a profile view of a Fragrance Element with a cactus-shaped cross-section.

FIG. 10 is a perspective view of a fully assembled configuration comprising four identical Modular Candle Elements arranged in a repeating circular perimeter pattern about a central axis. The Modular Candle Elements vary in height in this embodiment, contributing to a pillar-shaped outer form while maintaining an even upper surface.

FIG. 11 is a perspective view of a fully assembled configuration comprising four identical Modular Candle Elements arranged in a repeating circular perimeter pattern about a central axis. The Modular Candle Elements vary in height in this embodiment, and the assembled structure includes an undulating outer perimeter with eighteen evenly spaced convex lobes, illustrating an alternate perimeter geometry.

FIG. 12 is a perspective view of a fully assembled heart-shaped configuration formed from five full-length Modular Candle Elements, each having a distinct shape. The Modular Candle Elements interlock to define a non-repeating perimeter geometry. Five Fragrance Elements and one wick are shown installed within the assembled structure.

FIG. 13 is a perspective view of a fully assembled configuration comprising five identical Modular Candle Elements of varying height arranged in a repeating circular perimeter pattern about a central axis. One wick and five Fragrance Elements are shown installed within the assembled structure.

FIG. 14 is a perspective view of a fully assembled hexagon-shaped configuration composed of multiple full-length Modular Candle Elements, each having a distinct shape that interlocks with adjacent elements. Multiple wicks and Fragrance Elements are shown installed within the assembled structure.

FIG. 15 is a perspective partially exploded view of a multi-directional modular assembly configuration, in which Modular Candle Elements are configured to interlock along both vertical and horizontal axes. A directional arrow labeled (A1) indicates the vertical assembly direction, while arrow (A2) indicates the horizontal assembly direction for the elements. A Candle Assembly Foundation is shown supporting the structure and serving as a stabilizing base for the interlock process. One wick is shown installed within the partially assembled configuration, and four Fragrance Elements are depicted outside the structure with directional arrows labeled (A3) indicating their respective insertion paths. This embodiment illustrates dual-axis assembly functionality, enhanced structural complexity, and the use of foundational support for assemblies that do not inherently self-align.

FIG. 16 is a perspective view of the fully assembled configuration corresponding to the partially assembled structure shown in FIG. 15.

FIG. 17 is a top-down view of Modular Candle Elements arranged to illustrate geometric interlocking profiles, including male and female profile shapes. One Modular Candle Element is shown laterally offset from the assembly to illustrate its interface geometry. A Candle Assembly Foundation is shown at the base.

FIG. 18 is a sectional side view corresponding to the arrangement in FIG. 17, illustrating the engagement between opposing geometric interlocking profiles. One Modular Candle Element is shown in an inverted orientation prior to insertion, with directional assembly indicated by arrow (A4).

FIG. 19 is a perspective view showing one Modular Candle Element positioned above its corresponding location from FIG. 17, illustrating vertical assembly. A directional arrow labeled (A1) indicates the intended insertion path. The element includes a male geometric profile aligned for insertion into a complementary female profile.

FIG. 20 is a perspective view of the configuration from FIG. 19 with the Modular Candle Element fully seated in position, showing the engagement between the male and female geometric profiles.

FIG. 21 is a perspective view of a partially assembled pyramid-shaped configuration formed from Modular Candle Elements, each having an angled top surface that contributes to a continuous inclined profile when assembled. One Modular Candle Element is shown positioned above its intended location to illustrate directional assembly, as indicated by arrow (A1). A wick and Fragrance Elements are shown installed near the apex.

FIG. 22 is a perspective view of a step-pyramid configuration composed of stacked Modular Candle Elements arranged in tiers of progressively decreasing perimeter. A wick and multiple Fragrance Elements are shown installed near the apex.

FIG. 23 is an partially exploded perspective view of a four-sided pyramid configuration composed of Modular Candle Elements, illustrating vertical assembly with multiple elements shown in an inverted orientation prior to insertion. A directional arrow labeled (A1) indicates the vertical assembly direction, while arrow (A4) indicates the rotational alignment path used for installing inverted Modular Candle Elements. The figure depicts interlocking geometric profiles on adjacent elements and incorporates stepped features along one face of the structure. One wick is shown installed near the center, and cavities for receiving Fragrance Elements are visible within the partially assembled Modular Candle Elements.

FIG. 24 is a perspective view of the fully assembled configuration shown in FIG. 23. The assembled structure includes both smooth and stepped exterior faces with a wick and multiple Fragrance Elements installed near the apex.

FIG. 25 is a perspective view of a cylindrical configuration formed from Modular Candle Elements, in which a decorative image is segmented across multiple elements. Proper assembly of the Modular Candle Elements recreates the intended visual design.

FIG. 26 is a perspective view of a configuration comprising four identical Modular Candle Elements of uniform height arranged in a repeating circular perimeter pattern about a central axis. The elements may be arranged in different colors to create visual surface patterns.

FIG. 27 is a perspective view of a configuration similar to FIG. 26, comprising four identical Modular Candle Elements at approximately half the height of those in FIG. 26, arranged in a repeating circular perimeter pattern about a central axis. The reduced-height elements may be arranged in different colors to produce varied visual surface patterns.

FIG. 28 is a perspective view of a configuration comprising four interlocking Modular Candle Elements of varying height arranged in a repeating circular perimeter pattern about a central axis. The combination of mixed-height elements, such as those shown in FIG. 26 and FIG. 27, enables the creation of customized visual patterns through vertical variation.

FIG. 29 is a perspective view of a configuration comprising four interlocking Modular Candle Elements arranged in a repeating circular perimeter pattern about a central axis. The lower Modular Candle Elements have non-parallel upper and lower surfaces, with flat lower surfaces and angled upper surfaces that provide structural support as the base layer. The upper Modular Candle Elements have angled upper and lower surfaces that are parallel to each other, producing a uniform sloped surface profile across the assembled configuration.

FIG. 30 is a perspective view of a Non-Modular Candle Body comprising four cavities for receiving Fragrance Elements. One full-length, slot-shaped Fragrance Element is shown offset from its corresponding slot, with a directional arrow (A3) indicating the intended insertion path. The remaining three Fragrance Elements are shown installed along axes that extend from regions near the wick toward the outer perimeter of the candle body. Although the candle is depicted in an unlit state, the Fragrance Elements are arranged to correspond with regions that become thermally active during combustion.

FIG. 31 is a top-down view of the Non-Modular Candle Body shown in FIG. 30, with all four Fragrance Elements installed. Two concentric dashed circular reference lines are labeled (W) and (T), identifying the Wick Zone and the Thermal Activation Zone, respectively. The Wick Zone (W) defines a region proximate the wick suitable for positioning Fragrance Elements to preserve wax structure for wick support while maintaining proximity to early-stage thermal output. The Thermal Activation Zone (T) designates the area of the candle expected to reach sustained melt conditions during combustion. Each Fragrance Element is shown extending from within the Wick Zone (W), across the Thermal Activation Zone (T), illustrating one exemplary configuration for early-stage and sustained fragrance release.

FIG. 32 is a perspective view of an Assembly Key having a dovetail-shaped profile.

FIG. 33 is a profile view of a dovetail-shaped Assembly Key, illustrating its cross-sectional geometry.

FIG. 34 is a profile view of an Assembly Key featuring dual circular shapes.

FIG. 35 is a profile view of an Assembly Key featuring dual triangular shapes.

FIG. 36 is a profile view of an Assembly Key with a U-shaped cross-section.

FIG. 37 is a perspective view of a configuration comprising ten vertically oriented wedge-shaped Modular Candle Elements of varying height, arranged in a repeating circular perimeter pattern about a central axis. One Modular Candle Element is shown above its corresponding position, with a directional arrow labeled (A1) indicating the vertical assembly direction. A full-length vertical Assembly Key is shown offset from the structure, with a directional arrow labeled (A5) indicating its lateral insertion path. The Modular Candle Elements include cavities for receiving a wick, multiple Fragrance Elements, and Assembly Keys. One wick, five Fragrance Elements, and nine full-length vertical Assembly Keys are shown installed.

FIG. 38 is a perspective view of the fully assembled configuration of FIG. 37.

FIG. 39 is a perspective view of a cylindrical configuration comprising ten full-length wedge-shaped Modular Candle Elements arranged in a repeating circular perimeter pattern about a central axis. One Modular Candle Element is shown above its corresponding position with a directional arrow (A1) indicating vertical assembly. The Modular Candle Elements include dovetail-shaped cavities along their outer surfaces for receiving non-full-length horizontal Assembly Keys. Multiple Assembly Keys are shown offset from the perimeter with directional arrows indicating lateral insertion. The configuration includes five cavities for receiving Fragrance Elements and one cavity for a wick.

FIG. 40 is a perspective view of the fully assembled configuration of FIG. 39.

FIG. 41 is a perspective view of a configuration comprising four Modular Candle Elements arranged in a repeating circular perimeter pattern about a central axis and vertically stacked in sections of varying height. The figure illustrates the use of Assembly Keys oriented in both vertical and horizontal directions to connect stacked sections and to secure adjacent Modular Candle Elements along the outer perimeter.

FIG. 42 is a perspective view of a configuration comprising Modular Candle Elements of varying height arranged in a repeating circular perimeter pattern about a central axis. Although each Modular Candle Element shares the same general outer geometry, the locations of angled Assembly Key cavities may vary between elements. Several Assembly Keys are shown offset from the structure, with directional arrows (A5) indicating their angled insertion paths. This embodiment illustrates an alternate interlocking configuration utilizing Assembly Keys oriented along angled insertion paths across non-uniform vertical segments.

FIG. 43 is a top-down view of the fully assembled configuration shown in FIG. 42, with all Assembly Keys installed an angle.

FIG. 44 is a sectional view of the square-profile configuration shown in FIG. 43, illustrating the internal orientation of the Assembly Keys oriented along angled insertion paths.

FIG. 45 is a perspective view of the fully assembled square-profile configuration shown in FIG. 42, FIG. 43 and FIG. 44, with all components in place, including Assembly Keys oriented along angled insertion paths.

The figures are provided for illustrative purposes only and are not intended to limit the scope of the invention. Features shown in one embodiment may be combined with features of other embodiments, and variations in form, shape, configuration, and assembly may be implemented without departing from the scope of the invention as defined in the claims.

### DETAILED DESCRIPTION OF THE INVENTION

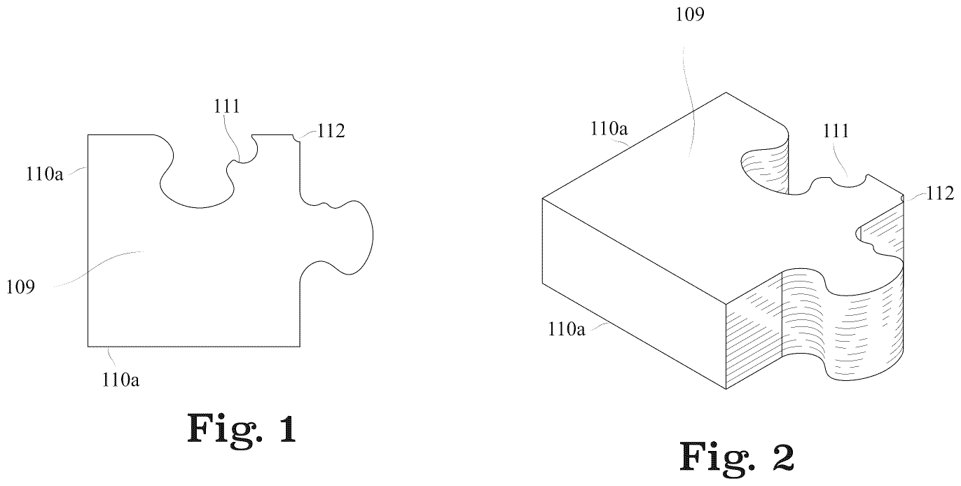

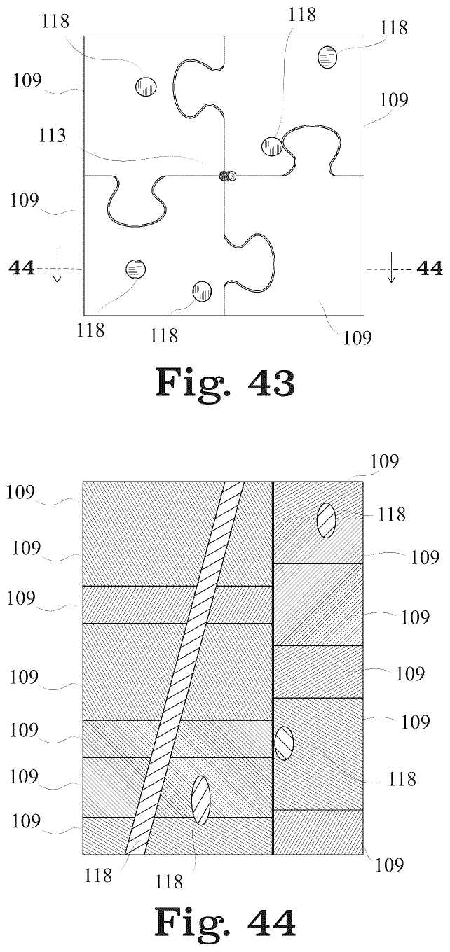

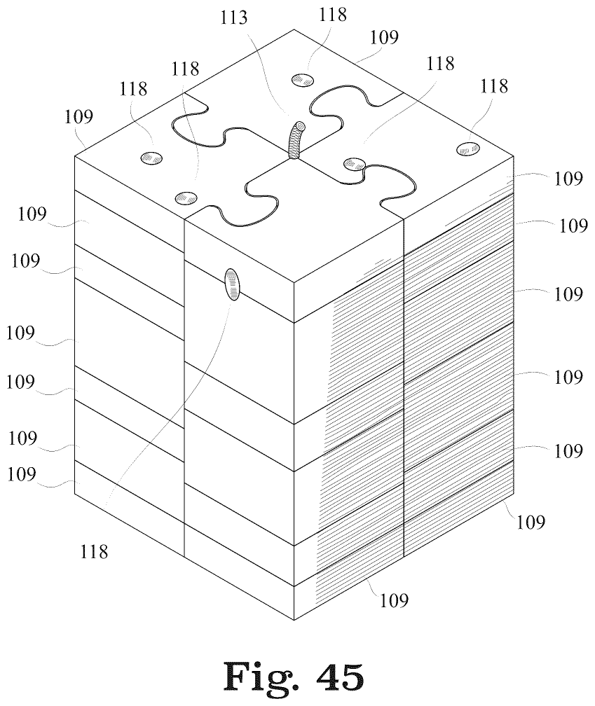

The following detailed description presents exemplary embodiments of the Multifunctional Constructive Wax Assembly (MCWA) to enable a full understanding of the invention's structure, function, and utility. Certain embodiments are hereinafter described in connection with the views and examples of FIGS. 1-45. While specific features are described in the context of particular figures, it should be understood that elements disclosed in one embodiment may be used in combination with features from other embodiments. All variations falling within the scope of the appended claims are intended to be covered.

### Modular Candle Elements and Assembly

Referring to FIG. 1 and FIG. 2, the MCWA includes Modular Candle Elements (109), each configured to interlock with adjacent Modular Candle Elements (109) to form a self-supporting candle structure. FIG. 1 shows an exemplary top-down profile, and FIG. 2 presents a perspective view of the same element. These Modular Candle Elements (109) may include interlocking profiles positioned at any location around or within the element body, including along perimeter-facing surfaces, interior cavity walls, or mating interfaces between adjacent elements.

Each Modular Candle Element (109) may include one or more cavities such as Fragrance Element Cavities (111), Wick Cavities (112), and Assembly Key Cavities (120) for receiving Fragrance Elements (114), wicks (113), or Assembly Keys (118). These cavities may take the form of recesses, through-channels, or partial bores, and may vary in quantity, shape, geometry, and depth. When Modular Candle Elements (109) are assembled, the respective cavities may align to define continuous or partially continuous channels for installing wicks, Fragrance Elements, Assembly Keys, or mechanical locking features. The interlocking geometry ensures functional component alignment, including cavity and channel continuity, and mechanically secures the Modular Candle Elements (109), maintaining structural cohesion under thermal and physical stress to prevent separation during handling or burning.

Modular Candle Elements (109) may be produced in a range of outer profile shapes and vertical dimensions. The elements may be uniform in height or varied, and may include angled or contoured upper surfaces. Each Modular Candle Element (109) may define a partial interlock or surface contour configured to mate with a corresponding feature of an adjacent element. The resulting engagement may rely on shape conformity, frictional fit, keyed alignment, or complementary engagement between adjacent outer surfaces. In some embodiments, these features are formed along outer profiles, edge contours, or boundary geometries that guide positioning and improve assembly stability.

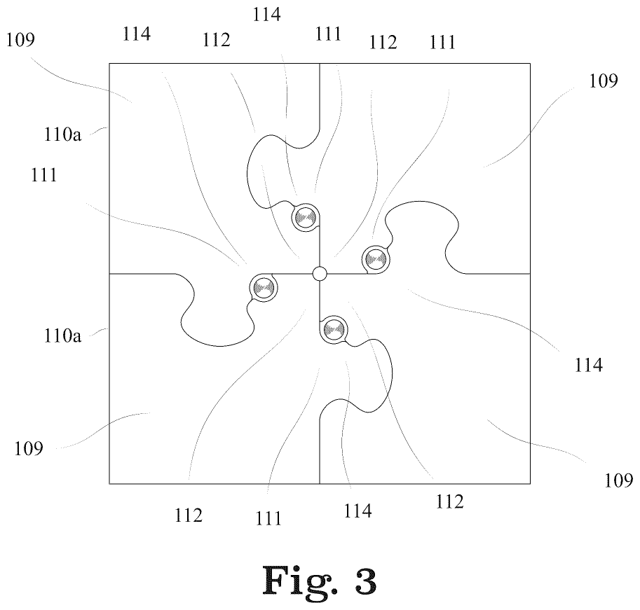

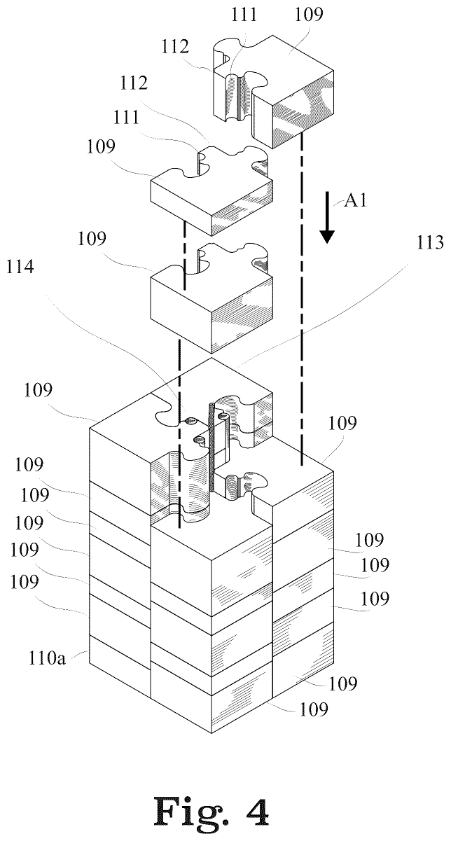

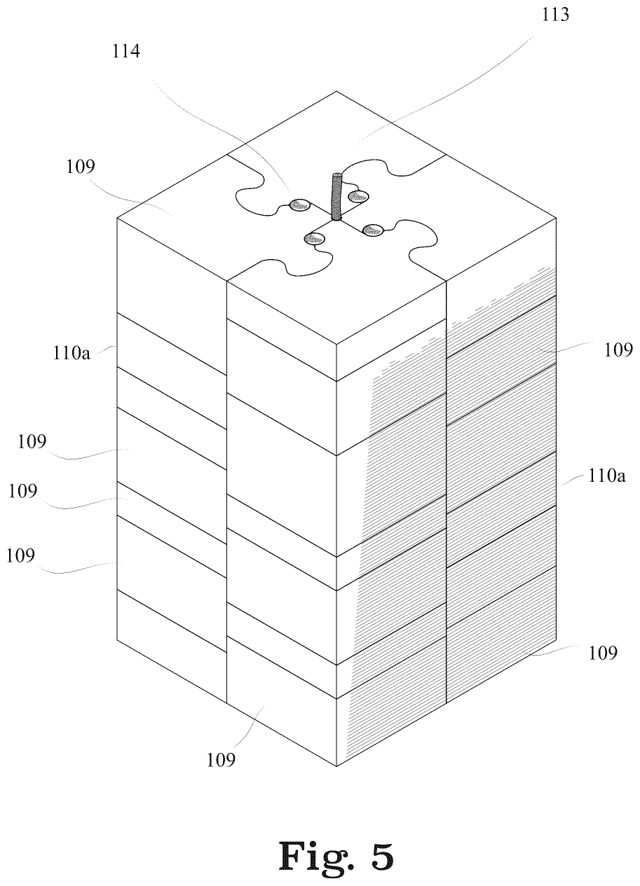

FIG. 3 illustrates a Candle Profile—Square (110a), formed by radial duplication of a single Modular Candle Element (109) geometry four times around a central axis to form a closed perimeter. The figure illustrates how partial cavities within each Modular Candle Element align upon assembly, similar to FIG. 3, to form continuous vertical channels for receiving a wick (113) and multiple Fragrance Elements (114). FIG. 4 illustrates assembly using Modular Candle Elements (109) of differing heights, with arrow (A1) indicating vertical placement. FIG. 5 depicts the completed assembly, showing installed components and interlocked seams. These figures collectively demonstrate how variation in element height contributes to both visual differentiation and increased assembly complexity through non-uniform interlocking geometry.

As used herein, the term “outer geometry” refers to the three-dimensional shape, contour, or boundary of an individual Modular Candle Element (109) in its unassembled state. This includes any exterior surfaces, outer profiles, or edges that define its form, regardless of whether the element ultimately contributes to the external perimeter of an assembled candle configuration. The term is intended to encompass elements used at internal, intermediate, or edge positions within a modular candle assembly.

Attachment between Modular Candle Elements (109) may rely solely on interlocking geometry or be augmented with additional securing mechanisms. These may include adhesives, heat-induced fusion of adjacent wax surfaces during initial combustion, or discrete mechanical locks such as integrated dovetail joints or Assembly Keys (118) configured for insertion into mating cavities between adjacent elements. As used herein, a structural support component may include, but is not limited to, an Assembly Key or other insertable element configured to reinforce or stabilize the assembled Modular Candle Elements.

Upon ignition, heat from the burning Wick (113) causes adjacent wax surfaces to melt and fuse along the interlocking seams between Modular Candle Elements (109). This post-assembly fusion further solidifies the structure, creating a visually continuous and mechanically cohesive assembly during use. In some embodiments, a completed Modular Candle assembly may be placed within a rigid or semi-rigid container, such as a glass jar, metal tin, or ceramic vessel, to support burning stability, containment, or presentation.

As used herein, the term “candle” refers to a structure composed of one or more combustible materials that are solid at room temperature and configured for combustion via a wick. A wick, as understood in the art, is a fibrous or combustible element that enables sustained ignition and controlled melting of the candle body. For the purposes of this disclosure, a candle requires a wick to function as intended. The wick may be embedded within a modular candle element, positioned between adjacent elements, or supported within a defined cavity or recess. The wick need not be fused to the wax, but must be present and positioned to facilitate ignition of the combustible material. A wax structure lacking a wick or means for combustion is not a candle as defined herein.

### Fragrance Element Geometry and Function

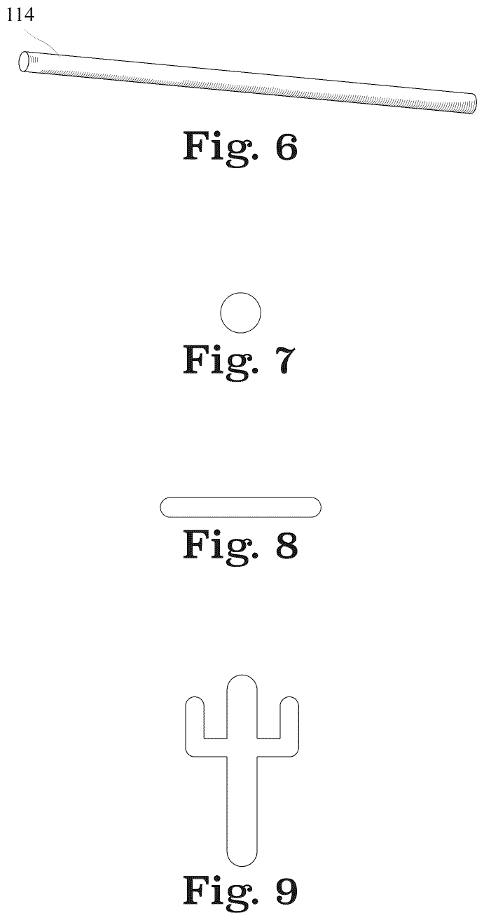

FIG. 6 and FIG. 7 illustrate different views of a cylindrical Fragrance Element (114), which may be inserted into vertical cavities formed across aligned Modular Candle Elements (109). FIG. 6 shows a perspective view of the cylindrical Fragrance Element (114), while FIG. 7 presents a profile view of the same Fragrance Element (114). Although compatible with the modular structure and Infuser-Compatible Candle (119), cylindrical Fragrance Elements (114) tend to become fully submerged within the wax pool during early combustion. As used herein, the term ‘infuser’ refers to a Fragrance Element (114) and may be used interchangeably in descriptive examples. This terminology does not imply any structural or functional distinction unless explicitly stated. More critically, their limited surface area and constrained fragrance load reduce overall diffusion efficiency within the melt pool. Because the fragrance is not pre-dispersed throughout the wax matrix and no active mixing occurs during combustion, a small cylindrical Fragrance Element introduces only a localized and transient concentration of fragrance. This often results in weak or short-lived aromatic output, insufficient to effectively release fragrance at sufficient intensity and duration to affect the surrounding air space. In contrast, infuser geometries with greater thermal exposure and broader melt pool distribution are better suited for sustained fragrance release.

FIG. 8 illustrates a Fragrance Element (114) having a slot-shaped profile and elongated form. This geometry provides sufficient volume to carry a high concentration of fragrance material throughout the infuser body, without requiring encapsulated oils or liquid reservoirs. The overall surface area and mass of the slot shape enable uniform, sustained distribution of fragrance into the wax pool as the infuser melts. Unlike infusers that rely on rigid outer shells or internal oil compartments, The fragrance material is homogeneously distributed throughout the solid composition of the Fragrance Element (114), which may be formed from a single wax or thermoplastic material, without requiring encapsulated oils or liquid reservoirs. In some embodiments, the infuser may be formed from a blend of waxes, thermoplastics, or other solid combustible materials having a higher melting point than the surrounding candle body, allowing it to remain partially exposed or melt more slowly depending on the burn duration. This partial surface exposure enables direct fragrance release at the melt pool-air interface, promoting stronger and earlier aromatic output. The higher melting point composition may also provide sufficient rigidity for manual handling and insertion into the respective cavities without deformation or breakage.

Performance is dependent on both the geometry and spatial positioning of the Fragrance Element (114) relative to the Wick (113), such that the fragrance material is gradually released into the melt pool during combustion and dispersed across the candle surface. Because the fragrance is not pre-blended into the wax matrix, the placement and length of the Fragrance Element Cavity (111) should be configured to promote both early-stage activation and sustained exposure to combustion-generated heat. Although no manual mixing occurs and the fragrance is not uniformly distributed within the wax matrix, localized thermal conduction and melt pool dynamics during combustion promote gradual dispersion of the released fragrance, functionally approximating the aromatic distribution of a pre-blended candle.

In exemplary embodiments, sustained fragrance release may be supported by locating at least a portion of the cavity within or adjacent to the Thermal Activation Zone (T), as designated in FIG. 31. The Thermal Activation Zone (T) represents a region of wax that reaches sufficient temperature during combustion to initiate fragrance volatilization. As used herein, the terms “Thermal Activation Zone,” “Thermal Zone,” and “Thermally Active Zone” are used interchangeably to describe this melt region. The exact size and location of this zone may vary depending on wick placement, wick size, wick material, wax formulation, and cavity geometry. The cavity may extend radially inward, radially outward, or be positioned at an angular offset relative to the wick position and design-specific factors such as container shape, thermal characteristics, or desired fragrance diffusion. FIG. 31 also illustrates the Wick Zone (W), which serves as an additional spatial reference for preferred infuser positioning.

In some embodiments, Fragrance Elements (114) may be positioned within or adjacent to the Wick Zone (W), which represents the immediate region surrounding the wick core. Because this area experiences the highest initial temperatures during ignition, proximity to the Wick Zone (W) may result in fragrance volatilization within approximately the first minute of combustion. This early-stage release enables prompt aromatic output at the beginning of the burn cycle, while the surrounding wax structure maintains wick stability. The functional requirement is that the cavity intersects a Thermally Active Zone (T) of the candle body capable of supporting reliable fragrance diffusion during typical use conditions.

In some embodiments, a single Fragrance Cavity (111) may receive multiple Fragrance Elements (114) inserted in series, thereby enabling vertical stacking to extend the fragrance distribution within the thermally active region (T) of the candle body. This configuration allows users to combine different fragrance compositions within a single cavity to achieve progressive or layered aromatic transitions during combustion. Additionally, separate Fragrance Cavities may be loaded with distinct Fragrance Elements to produce customized or complementary fragrance profiles. The selection and placement of Fragrance Elements, whether stacked within a single cavity or distributed across multiple cavities, may be user-controlled to influence fragrance intensity, timing, and overall aromatic character as the candle burns.

In practical implementations, the extent and geometry of the Thermal Activation Zone (T) may vary based on wick characteristics, wax composition, ambient conditions, and whether the candle is contained or freestanding. Melt pool behavior is commonly evaluated in the industry through internal testing protocols that measure melt pool diameter under controlled conditions to assess thermal distribution. For example, a wick may produce a melt pool of approximately 1.83 inches in diameter when embedded in specific paraffin wax under standard laboratory conditions. In real-world use, the effective Thermal Zone may expand due to vessel heat retention or contract due to cooler ambient temperatures or alternative wax types. Accordingly, the placement of the Fragrance Element (114) within or adjacent to the Thermal Activation Zone (T) is configured to enable consistent fragrance release under typical conditions, while accommodating thermal variability arising from material or environmental factors.

FIG. 9 illustrates exemplary shape variations of Fragrance Elements (114), demonstrating that the infuser body may be formed in decorative or non-linear geometries, such as curved, zigzag, or contoured profiles. These alternative shapes may be selected for aesthetic purposes, structural fit, or to control fragrance release dynamics. Infusers may be produced from wax, thermoplastic, or elastomeric blends, and may incorporate additives such as glitter, luminescent pigments, colorants, or encapsulated fragrance payloads. Partial-length and full-length infusers are contemplated, and multiple infuser geometries may be used in a single assembly. In some embodiments, Fragrance Elements may further include embedded decorative or informational components such as company branding, logos, QR codes, RFID elements, or other traceable identifiers.

As used herein, the term “Wick Zone (W)” refers to a localized placement region surrounding a wick (113), within which a Fragrance Element (114) may be positioned to achieve early-stage fragrance activation while maintaining sufficient spatial configuration to support wick stability and structural integrity, which may include direct contact or separation depending on the embodiment. The Wick Zone (W) may be centered about an individual wick and may vary in size and shape depending on wax composition and wick size. In single-wick configurations, the Wick Zone (W) generally occupies a proximal area surrounding the wick; in multi-wick embodiments, overlapping Wick Zones may define shared insertion regions between adjacent wicks. FIG. 31 illustrates an exemplary Wick Zone with a dashed circular boundary labeled (W), shown centrally within the illustrated embodiment. While this visual reference provides spatial context, it does not define the precise limits of thermal activation. Rather, it serves as a visual aid for identifying preferred infuser entry zones that balance structural support with proximity to the Thermal Activation Zone (T), the surrounding melt region expected to sustain sufficient temperature during combustion to enable fragrance release.

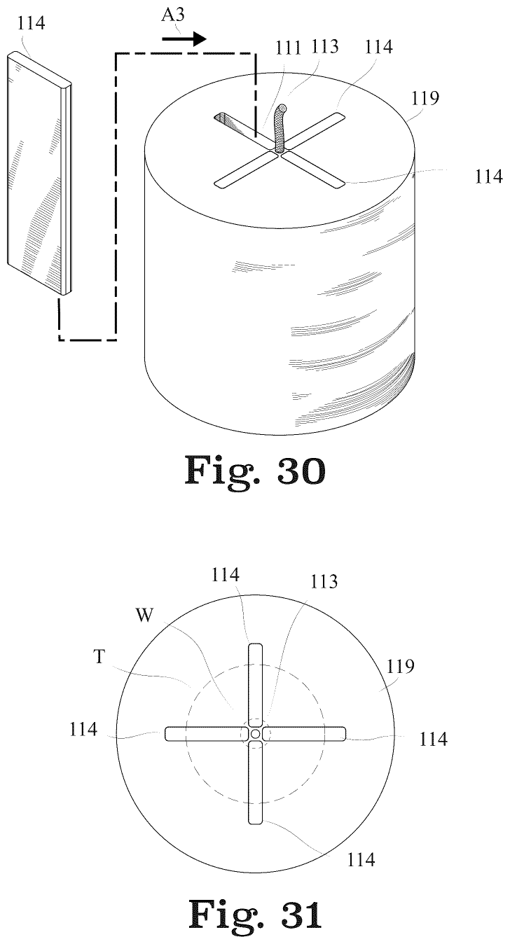

FIG. 30 and FIG. 31 depict a single-wick configuration with four Fragrance Elements (114) positioned to extend outward from the Wick Zone (W). Similar spatial principles apply to multi-wick configurations incorporating two, three, or more wicks. In such embodiments, Fragrance Elements (114) may be positioned adjacent to individual wick zones and extend radially outward or inward depending on the wick layout. In alternative configurations, infusers may originate near the outer edge of the candle and extend inward toward one or more wick zones, or may be positioned between multiple wicks, inserted into a cavity that spans or serves multiple wicks and corresponding Thermal Activation Zones (T). Regardless of orientation, the essential design feature is alignment with heat zones produced by active wicks, enabling consistent fragrance activation and diffusion during the burn cycle.

### Outer Profiles and Configurability

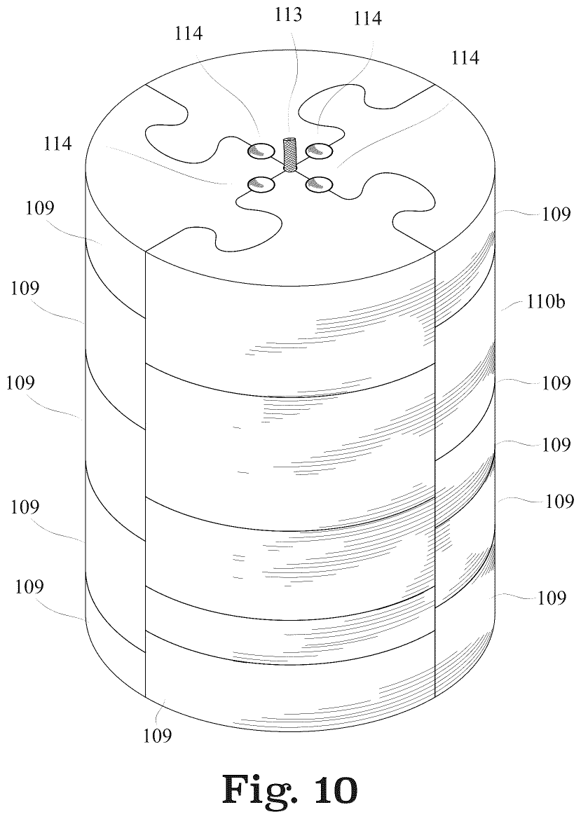

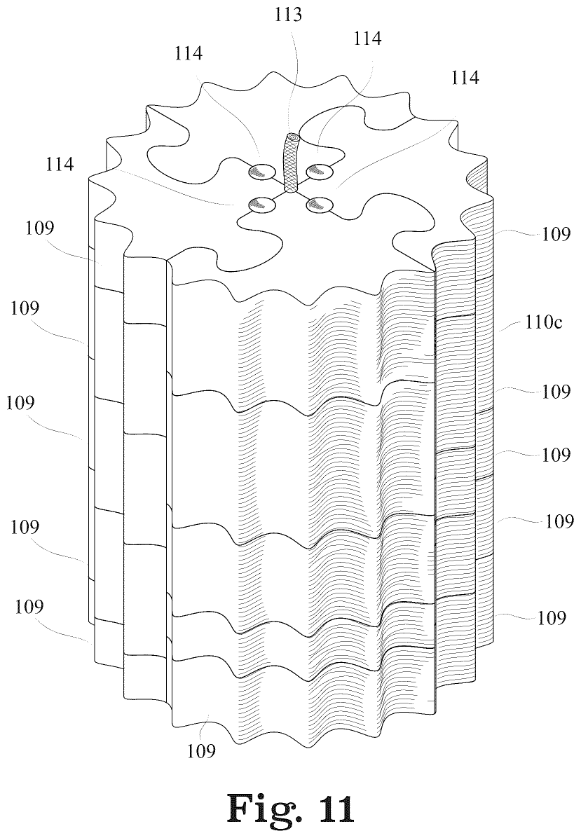

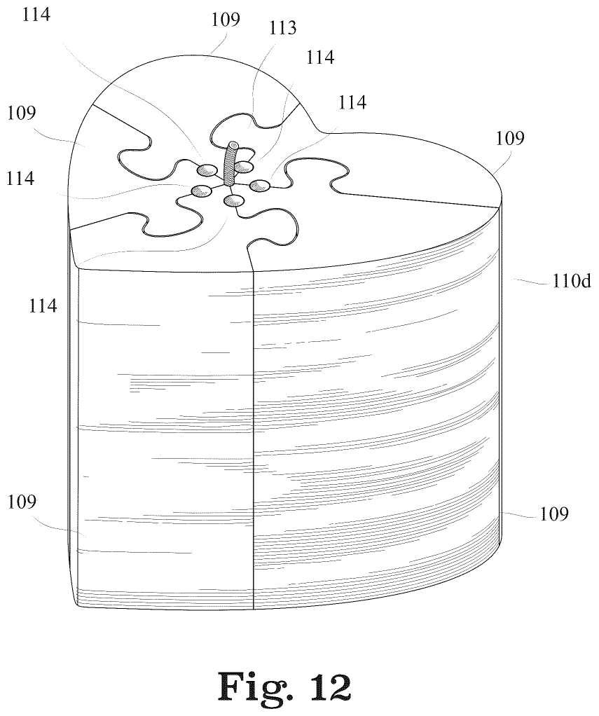

FIGS. 10-12 illustrate assembled candle configurations having different outer profiles, achieved by varying the perimeter geometry and arrangement of Modular Candle Elements (109). FIG. 10 and FIG. 11 present alternate perimeter treatments applied to the same structural assembly shown in FIG. 5. Each configuration is formed by radial duplication of a single Modular Candle Element (109) geometry four times around a central axis to form a closed perimeter, with the elements varied in vertical height. FIG. 10 depicts a Candle Profile—Cylindrical (110b), while FIG. 11 illustrates a Candle Profile—Eighteen-Lobed (110c), where the outer edge geometry of the elements has been modified to produce an undulating perimeter. In contrast, FIG. 12 introduces a Candle Profile—Heart (110d), constructed from five distinct Modular Candle Elements (109) of uniform height. Unlike the repeating patterns in FIG. 5, FIG. 10, and FIG. 11, the configuration in FIG. 12 comprises non-repeating geometries, each uniquely contributing to the assembled profile.

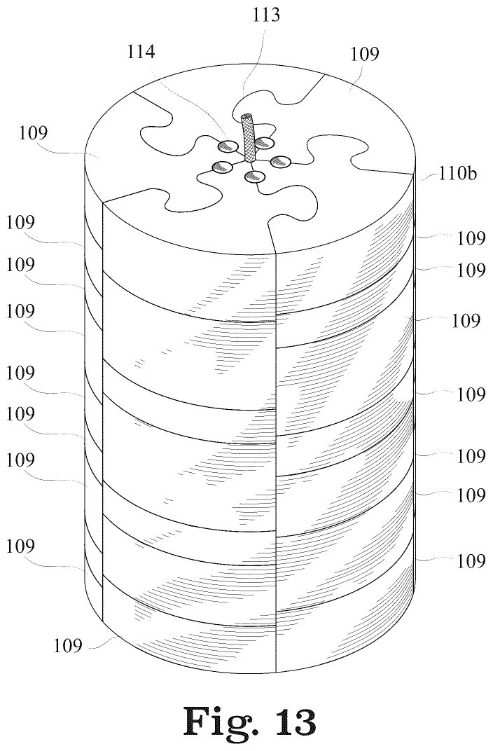

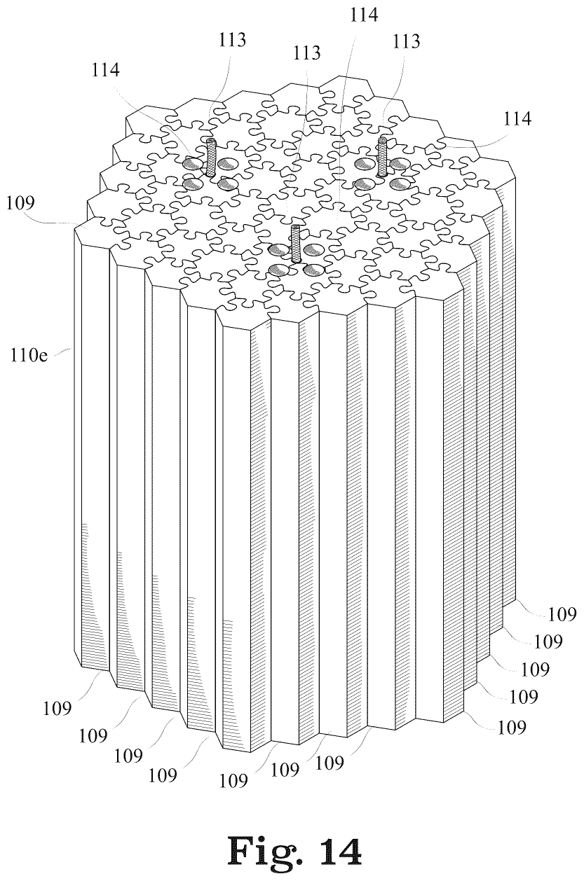

Modular Candle Elements (109) may be arranged in circularly repeating or non-repeating perimeter configurations comprising three, four, five, or more elements. In a circularly repeating configuration, a single Modular Candle Element (109) geometry is radially duplicated around a central axis to form a closed assembly. Within either configuration type, elements may be uniform or varied in height, allowing for enhanced visual complexity and more intricate interlock geometries. FIG. 13 illustrates a cylindrical assembly formed by circular repetition of a single Modular Candle Element (109) five times, with each element varied in vertical height. FIG. 14 depicts a non-repeating assembly comprising sixty-one full-length Modular Candle Elements (109), each having a distinct interlocking shape. This configuration demonstrates the ability to construct complex assemblies using traditional puzzle-like geometries. In some embodiments, variation in the vertical height of the individual elements may be introduced to further increase assembly complexity and visual differentiation. The embodiment of FIG. 14 also includes three wicks (113) and twelve Fragrance Elements (114), although their inclusion is illustrative and not limiting to the assembly complexity demonstrated.

### Multi-Directional Assembly

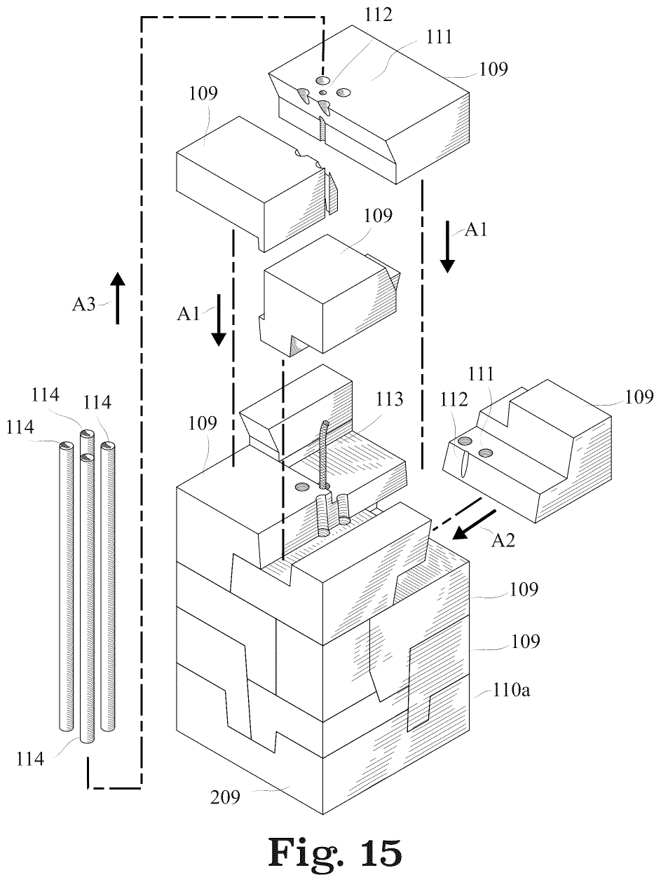

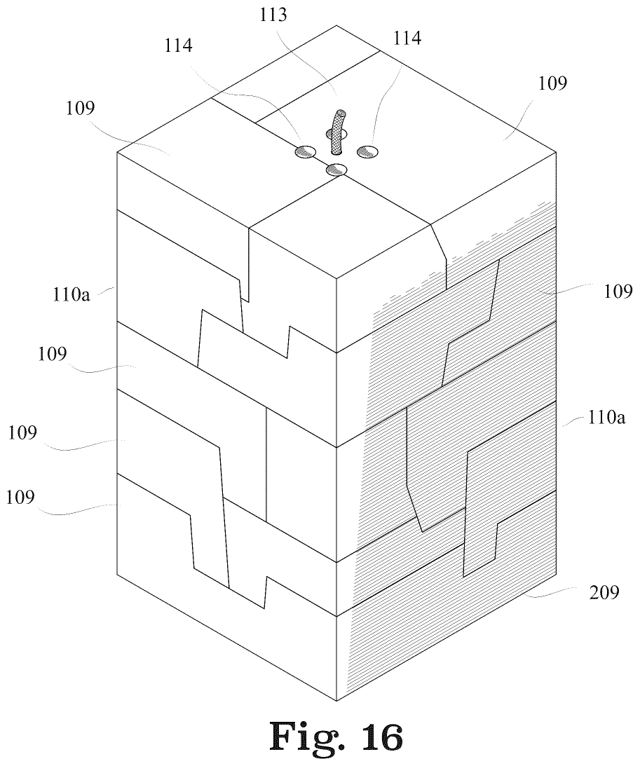

FIG. 15 and FIG. 16 introduce a multi-directional assembly embodiment in which Modular Candle Elements (109) are configured to interlock along both vertical and horizontal axes. FIG. 15 is a partially exploded perspective view illustrating the Modular Candle Elements (109) prior to engagement, with directional arrows (A1), (A2) and (A3) indicating the vertical stacking, horizontal element insertion, and vertical Fragrance Element insertion directions, respectively. Arrow (A1) designates the vertical stacking direction, while arrow (A2) represents the lateral sliding direction for horizontal insertion. Fragrance Elements are positioned outside the structure, with directional arrows (A3) indicating their intended insertion paths into corresponding vertical cavities within the Modular Candle Elements. This dual-axis interconnectivity enables the formation of integrated structures that lock together across multiple planes, increasing both assembly complexity and final structural stability.

FIG. 16 shows the fully assembled configuration resulting from the engagement illustrated in FIG. 15, with all Modular Candle Elements (109) interlocked into a unified structure. In the illustrated embodiment, the Modular Candle Elements (109) form a substantially flat upper surface; however, alternative configurations may utilize varied or contoured element geometries to produce non-flat top profiles, depending on the design of the kit.

### Foundations

In certain embodiments, a Candle Assembly Foundation (209) is provided as a stabilizing base to support the construction or presentation of the assembled candle. While FIG. 15 and FIG. 16 depict a foundation matched to the perimeter footprint of a multi-directional assembly, other embodiments may utilize foundations of varied dimensions or shapes that do not necessarily correspond to the candle base. The foundation may assist with vertical (A1) and horizontal (A2) element alignment during assembly, particularly for configurations involving asymmetrical, multi-level, or non-repeating geometries that lack inherent self-alignment. In other cases, the foundation may serve purely aesthetic or accessory roles, enhancing presentation or supporting branding. Its inclusion is optional and may be determined by structural needs, consumer preference, or kit configuration.

The Candle Assembly Foundation (209) may be formed from wax or from non-wax materials such as rigid polymers, stone, metal, glass, or wood. In some embodiments, the foundation serves both structural and aesthetic functions and may optionally incorporate colorants, branding, or embedded fragrance. Structural features such as recesses, mating edges, or alignment grooves may be included to facilitate precise positioning and secure engagement of Modular Candle Elements (109) during assembly. Once the candle is fully constructed, the foundation may also function as a transport base or integrated display platform, optionally including features such as handles, trays, or decorative treatments to support movement, presentation, or reuse.

### Geometric Interlocks

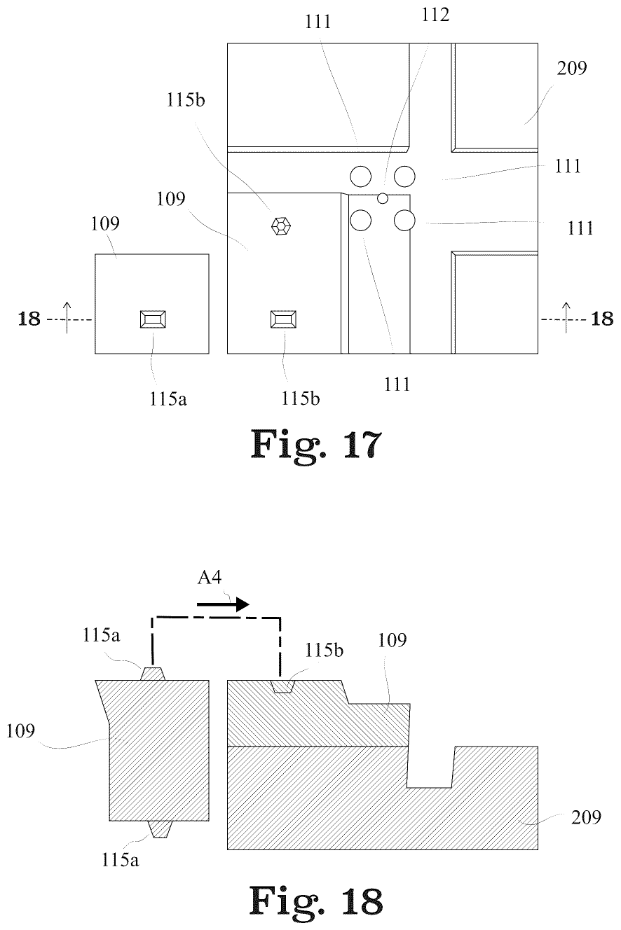

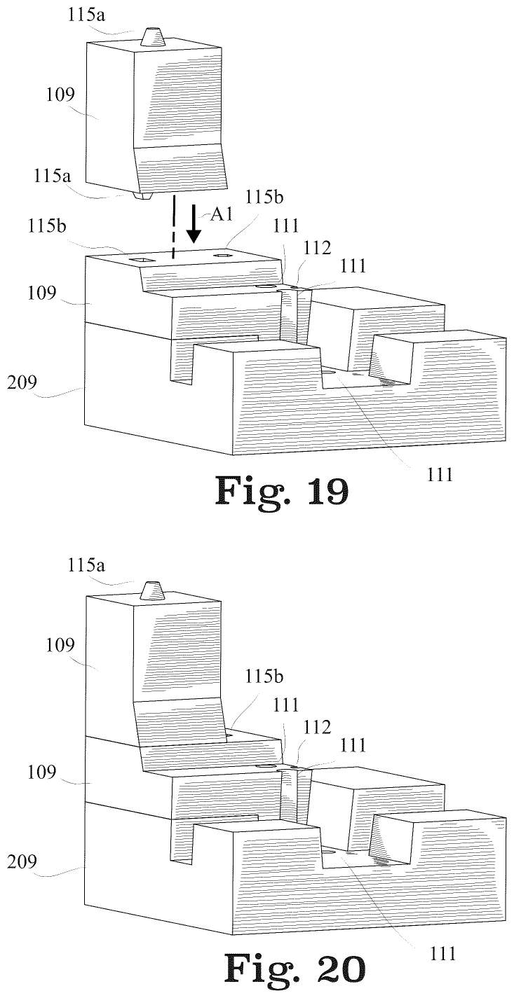

FIGS. 17-20 illustrate exemplary Modular Candle Elements (109) incorporating geometric interlocks that facilitate secure alignment and engagement between adjacent elements. As shown in the top-down view of FIG. 17, each Modular Candle Element (109) includes at least one interlock profile, such as a Geometric Profile—MALE (115a) or a Geometric Profile—FEMALE (115b), configured to engage with a complementary profile on a mating Modular Candle Element (109). These profiles may take the form of trapezoidal, tapered octagonal, or other geometries that permit flush alignment and secure interlocking engagement. FIG. 18 presents a sectional view corresponding to FIG. 17, showing the opposing interlock profiles and directional arrow (A4), which indicates the installation direction when one element is inverted for engagement. FIG. 19 and FIG. 20 further illustrate vertical interlock insertion along arrow (A1). The interlock configuration is not limited to fixed male or female assignment; rather, elements may include one or more profiles in either form, provided that mating surfaces are complementary. These geometric interlocks enhance both vertical and horizontal structural cohesion and enable precise, repeatable placement across complex assembly configurations.

### Sculptural Assemblies and Thematic Geometries

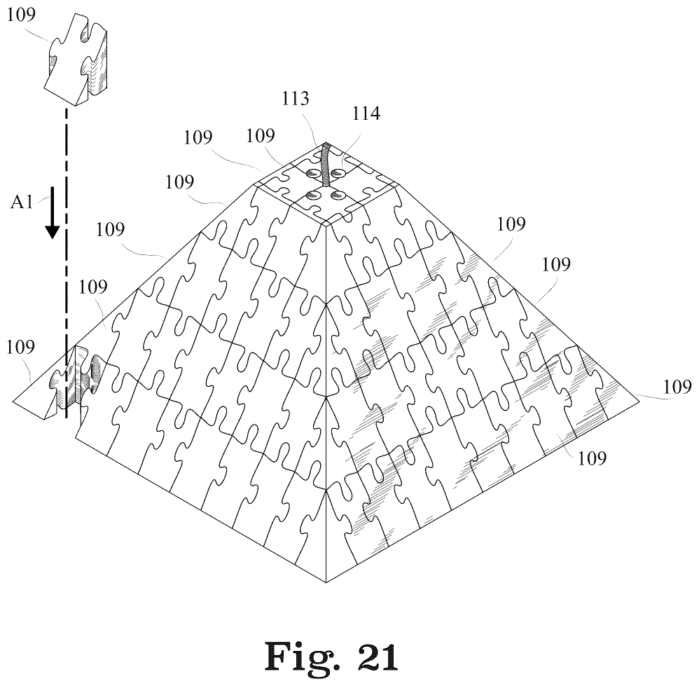

FIGS. 21-24 present exemplary embodiments of the MCWA system configured to form pyramid-style candle assemblies. These embodiments demonstrate how Modular Candle Elements (109) may be shaped and arranged to create complex three-dimensional structures that incorporate angular, stepped, protruding, or sculpted contours. FIG. 21 shows a smooth-walled, four-sided pyramid-shaped assembly with one Modular Candle Element (109) elevated above its final position to illustrate vertical insertion along arrow (A1). In this embodiment, each element's top surface is cut at an angle to align flush with adjacent elements, enabling the formation of a contiguous pyramidal apex. This angling may be combined with interlocking geometries or variable element heights to enhance both assembly precision and visual intricacy. While FIG. 21 illustrates a single wick (113) and four Fragrance Elements (114), the number, positioning, and inclusion of such components may vary and are not limiting to the structural assembly shown.

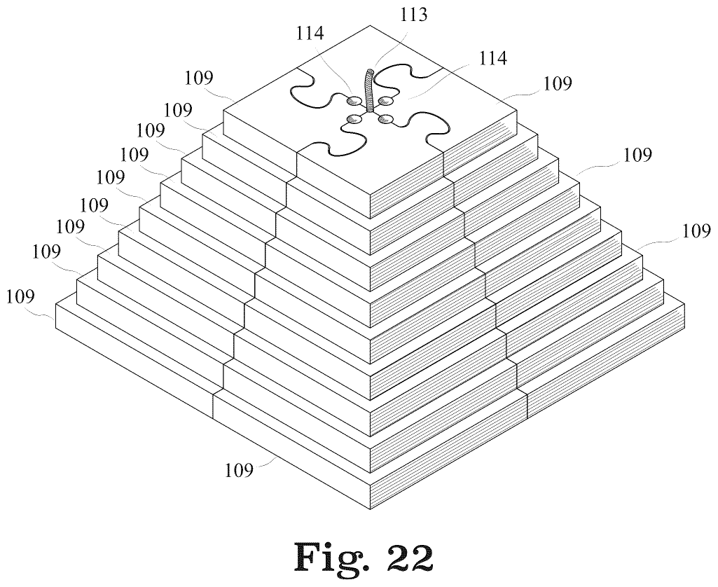

FIG. 22 depicts a step pyramid configuration inspired by historical architecture such as the Djoser pyramid of Egypt. In this embodiment, Modular Candle Elements (109) are arranged in stacked tiers of decreasing perimeter dimensions, resulting in a progressively tapered form. The stepped contour introduces visual complexity and expands design versatility, allowing for variation in color, fragrance, or element height across tiers. The drawing emphasizes the sculptural configuration of the assembly; specific interlocking geometries are not depicted and may vary by embodiment.

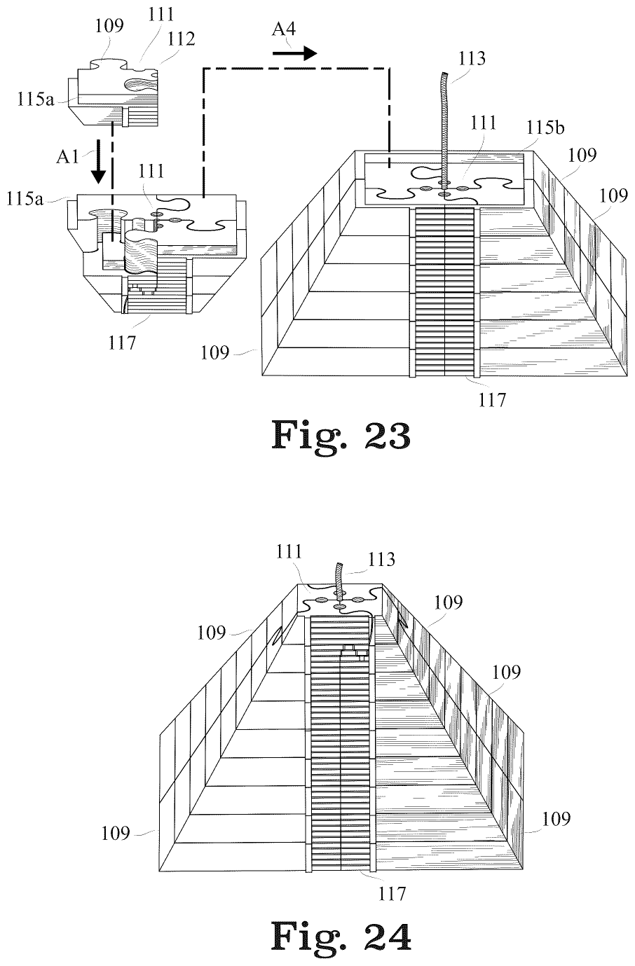

FIG. 23 and FIG. 24 introduce Visual Design Component (117) integrated into Modular Candle Elements (109), exemplified by stepped projections along a single face of the pyramid, though multiple-face variations are contemplated. These features resemble temple-like steps as found in structures such as EI Castillo in Mexico. FIG. 23 illustrates partial assembly with the top section removed and rotated to highlight Geometric Profile—MALE (115a) and Geometric Profile—FEMALE (115b) interlocks, and directional arrows (A1) and (A4) indicating vertical insertion and rotational alignment respectively. FIG. 24 shows the fully assembled configuration, combining stepped and smooth faces to emphasize the design flexibility of the MCWA system. Visual Design Components (117) may be sculptural, thematic, or symbolic, allowing users to create decorative and structurally coherent designs with high aesthetic impact. In some embodiments, Modular Candle Elements may incorporate Visual Design Components that are either pre-formed during manufacturing or optionally user-customizable through methods such as modular inserts, removable decorative overlays, or sculptable surface layers. Such customization techniques, where implemented, may enable enhanced aesthetic personalization without departing from the structural integrity of the assembled candle.

### Decorative and Functional Enhancements

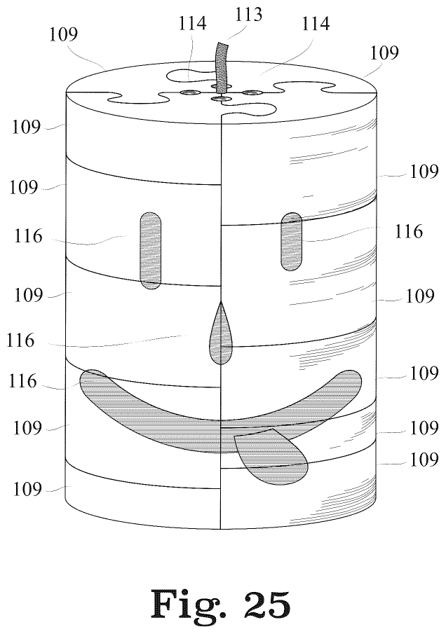

FIG. 25 illustrates an embodiment of the MCWA system wherein Decorative Images (116) are applied to the exterior surfaces of Modular Candle Elements (109) to create an image-based puzzle assembly. In the example shown, an illustrative facial image, comprising two eyes, a nose, and a smiling mouth with a protruding tongue, is distributed across multiple Modular Candle Elements (109). When the elements are correctly positioned, the full image is revealed, reinforcing proper spatial orientation and providing visual confirmation of accurate assembly. This feature transforms the MCWA into a dual-mode puzzle experience by combining traditional two-dimensional image reconstruction with three-dimensional interlocking assembly. This structural configuration additionally enables puzzle-like reconstruction, wherein successful assembly is dependent on proper alignment of shape, orientation, and decorative features. Such assemblies may involve both trial-and-error and visual-spatial logic, enhancing user interaction and extending beyond mere decorative stacking. The assembly shown in FIG. 25 corresponds structurally to the configuration illustrated in FIG. 10, with the addition of Decorative Images (116) applied to exterior surfaces. Although illustrated in connection with the four-element circular configuration of FIG. 10, Decorative Images (116) may be applied to Modular Candle Elements (109) in any arrangement, including non-circular or non-repeating assemblies, to support image-based reconstruction across a wide variety of structural formats.

Decorative Images (116) may include photographic-quality prints, illustrations, patterns, logos, branding, or symbolic representations, and may be applied to one or more surfaces of each element through engraving, transfer printing, surface embedding, incorporation into the wax material, or other image-transfer or fabrication methods. In some embodiments, multiple images may be applied across different surfaces, enabling the same Modular Candle Elements (109) to produce alternate visual outcomes depending on the assembly configuration. This capability supports enhanced customization, creative reassembly, and user engagement. The inclusion of Decorative Images (116) is optional and may be omitted without affecting the structural functionality of the MCWA system. In additional embodiments, image content may be customized for thematic collections, personalized kits, retail branding, or promotional purposes.

### User-Defined Visual Patterns and Modular Geometry

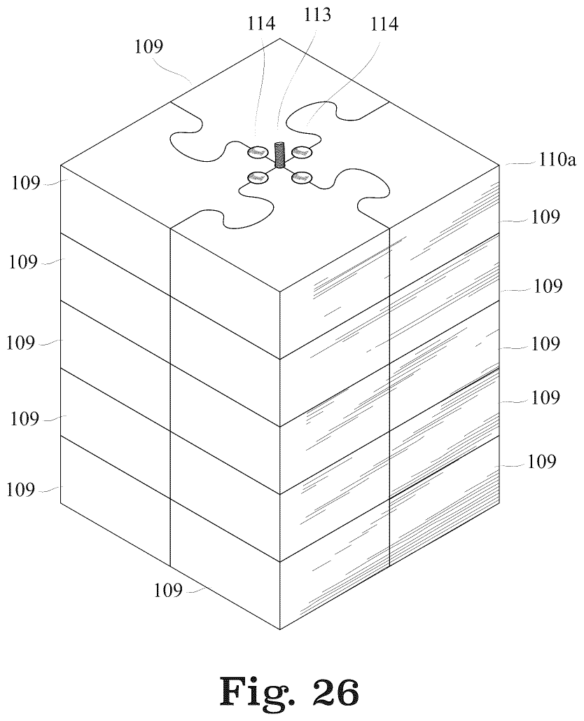

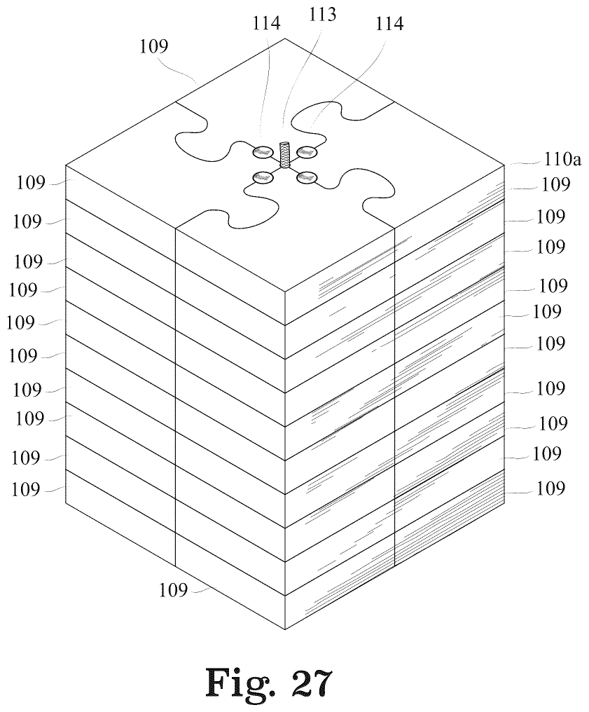

FIGS. 26-29 illustrate aesthetic and geometric variations in Modular Candle Element (109) assemblies, enabling user-defined visual patterns without altering the structural functionality of the MCWA system. FIGS. 26-28 show a square-profile configuration formed by radial duplication of a single Modular Candle Element (109) geometry four times around a central axis to form a closed perimeter. In FIG. 26, each element has a uniform height. FIG. 27 depicts the same configuration with elements having approximately half the height of those shown in FIG. 26. FIG. 28 illustrates a mixed-height configuration, combining both taller and shorter Modular Candle Elements (109) from FIG. 26 and FIG. 27 to generate alternating vertical contours and increased visual variation.

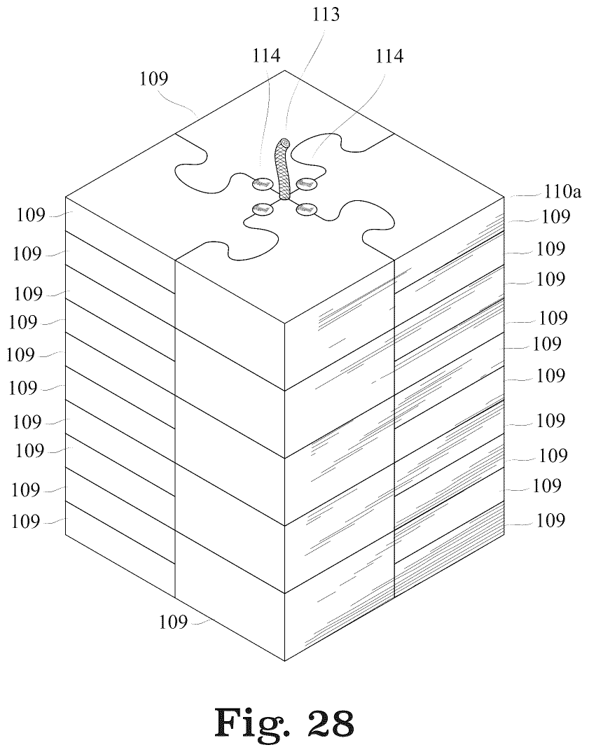

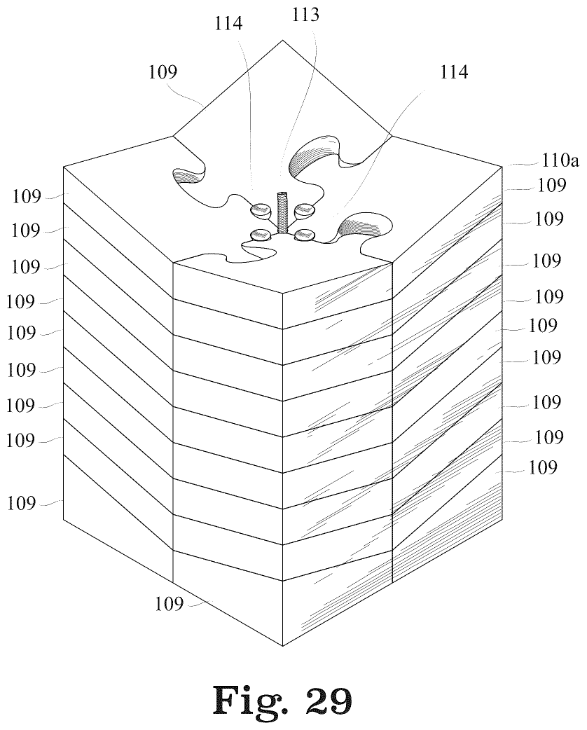

In practical retail implementations, Modular Candle Elements (109) may be offered in a range of colors, finishes, or surface treatments to support user-customized visual arrangements. These elements may be selected individually and combined by the end user to produce patterns, gradients, or symbolic compositions based on personal preference. FIG. 29 illustrates a variant configuration in which the bottom Modular Candle Elements (109) include angled upper surfaces and flat lower surfaces, while the upper elements incorporate angled upper and lower surfaces that are parallel to one another. The resulting structure exhibits a continuous sloped top surface across the assembled configuration. Color variation, where present, is used exclusively for visual customization and does not affect the interlocking function, combustion behavior, or structural stability of the MCWA system. All visual enhancements described herein are optional and non-limiting.

### Infuser-Compatible Candle Embodiment

FIG. 30 and FIG. 31 depict an Infuser-Compatible Candle (119), a stand-alone embodiment of the MCWA system configured to receive Fragrance Elements (114) without requiring Modular Candle Elements (109). This candle includes pre-formed Fragrance Element Cavities (111), which begin within or near the Wick Zone (W) and extend radially into the candle body. This fixed-cavity configuration allows fragrance customization in non-modular formats, while ensuring heat proximity suitable for early-stage diffusion. In FIG. 30, one Fragrance Element (114) is shown offset from its cavity, with directional arrow (A3) indicating insertion. FIG. 31 also designates the Thermal Activation Zone (T), into which the cavity may partially or fully extend depending on performance goals.

As used herein, the term “Infuser-Compatible Candle” refers to a non-modular candle configuration formed as a single-body structure composed of a flammable material, solid at room temperature, rather than from multiple modular elements. This structure defines a unified candle body that may include one or more cavities for receiving Fragrance Elements, wicks, or other components. The term “non-modular candle” is used interchangeably herein to describe such unitary candle forms that are not designed for user assembly from discrete interlocking pieces.

The Infuser-Compatible Candle (119) may be manufactured using, without limitation, methods such as cavity molding, wax machining, extrusion, casting, or additive fabrication, or any process capable of forming fixed cavities within a wax body. In container-based formats, the jar base may act as a physical stop for Fragrance Element (114) insertion. In freestanding embodiments, cavity ends may be closed, or may remain open where the support surface itself provides a physical stop to support proper burn progression and Fragrance Element retention. Fragrance Elements (114) may fuse into the candle body during early combustion, enhancing stability and user safety. Cavity orientation is generally vertical, but may be varied in future configurations.

In all embodiments, the Fragrance Element (114) is structurally and materially configured for thermal activation under typical combustion conditions. The infuser's shape, placement, and composition are not ornamental but functional, and directly influence the timing, intensity, and duration of fragrance output.

### Assembly Keys

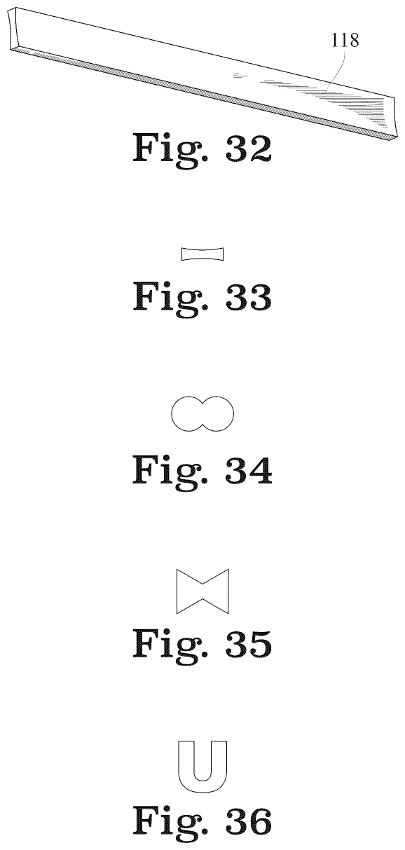

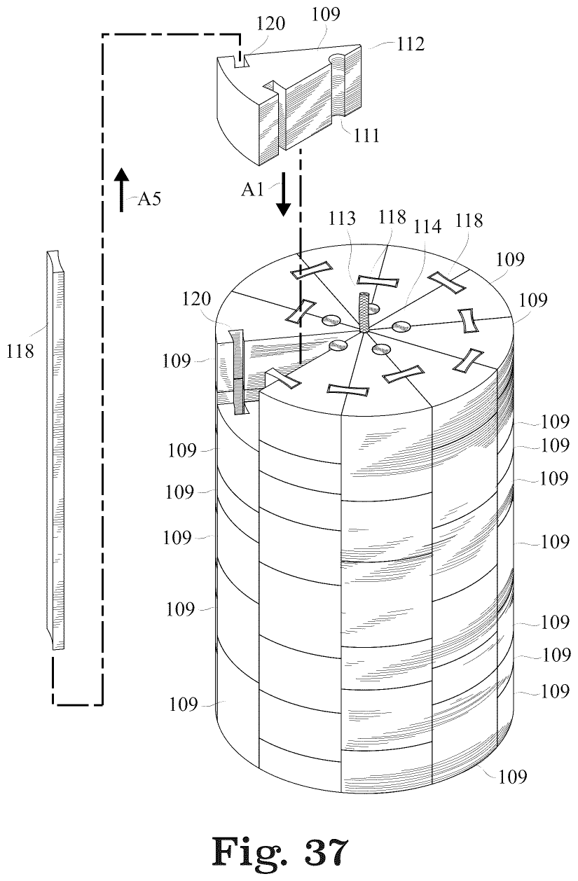

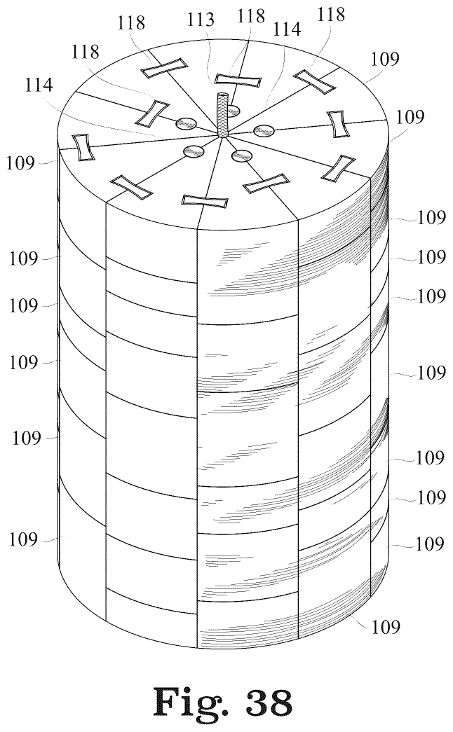

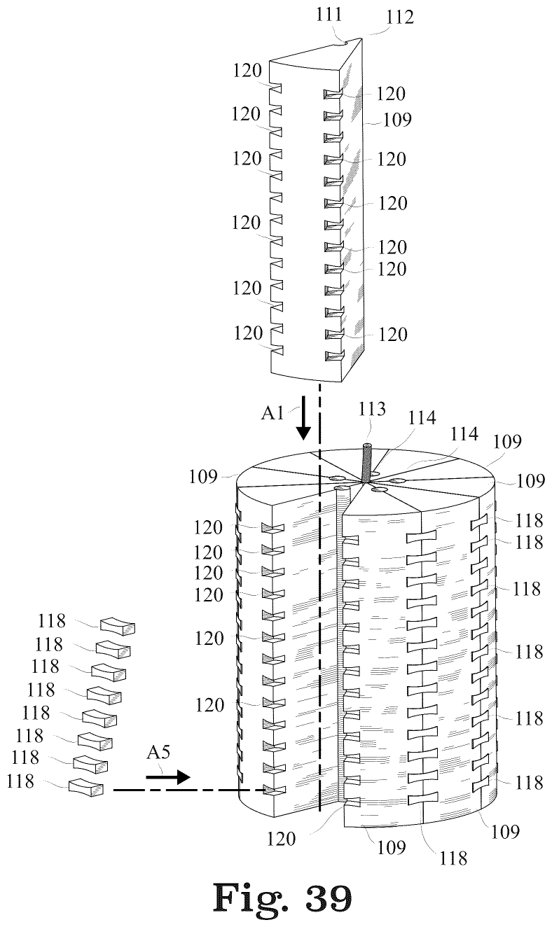

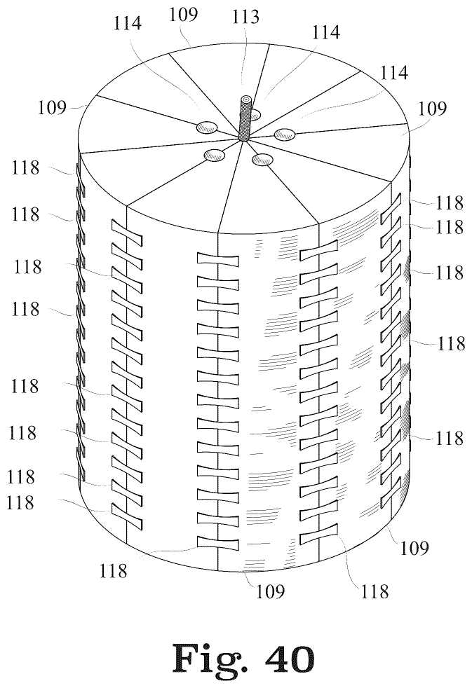

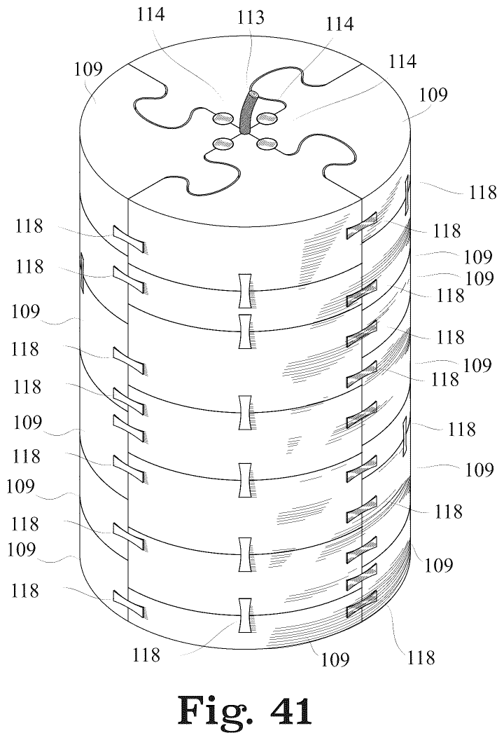

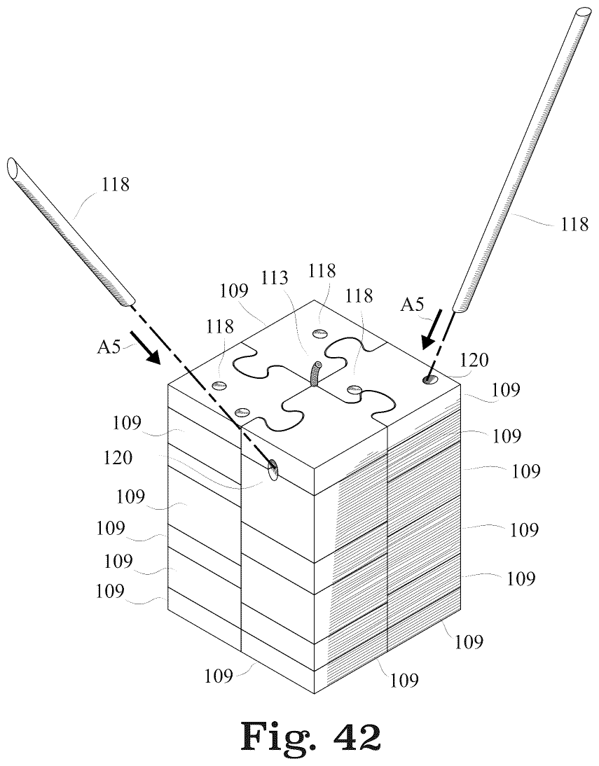

FIGS. 32-45 present various embodiments utilizing Assembly Keys (118) and corresponding Assembly Key Cavities (120) to structurally secure Modular Candle Elements (109) across one or more axes. Assembly Keys (118) may be inserted vertically (e.g., FIGS. 37-38), horizontally (e.g., FIGS. 39-40), both vertically and horizontally (e.g., FIG. 41) or at oblique angles (e.g., FIGS. 42-45), depending on the design requirements of the assembly. In FIG. 37, a directional arrow (A5) indicates the intended vertical insertion path of an Assembly Key (118) into a corresponding Assembly Key Cavity (120). In FIG. 39, arrow (A5) similarly denotes horizontal insertion into an opposing Assembly Key Cavity (120), while in FIG. 42, directional arrow (A5) marks an oblique or diagonal insertion path into an angled Assembly Key Cavity (120). These keys are configured to engage with complementary Assembly Key Cavities (120) formed within the Modular Candle Elements (109), providing mechanical and/or frictional interlock akin to woodworking joinery. Profile variations include dovetail (FIGS. 32-33), dual-circle (FIG. 34), dual-triangle (FIG. 35), and U-shaped geometries (FIG. 36), among others. Keys may also adopt cylindrical or fragrance-infuser-matching profiles for aesthetic alignment. When inserted, Assembly Keys (118) may press inward against opposing cavity walls to provide frictional engagement, or may function as positional alignment pins seated within corresponding cavities, depending on the geometry and fit tolerance of the mating features. In all cases, the keys serve to maintain the assembled configuration during handling, transport, and use.

The Assembly Keys (118) may be full-length or partial, and constructed from the same or distinct materials as the Modular Candle Elements (109), allowing varied melting behavior, aesthetic contrast, or enhanced rigidity. In some embodiments, keys may include embedded fragrance, decorative features such as colorants, logos, or ornamental textures, or may incorporate informational or traceable elements such as embedded RFID tags, QR codes, or branding elements to support identification, customization, or user interaction. Vertical keys may span stacked Modular Candle Elements, while horizontal and angled keys bridge adjacent elements at consistent or varied elevations. Angled cavities (e.g., FIG. 44) may pass diagonally through multiple vertically stacked Modular Candle Elements, requiring strategic alignment during assembly. In some embodiments, Assembly Keys (118) may be positioned along interior seams or around the exterior perimeter of the assembly, including tangential or edge-mounted configurations. Keys may be inserted to full or partial depth, depending on the desired retention force, structural thickness, or aesthetic objective. These flexible insertion schemes enable secure engagement across a broad range of structural formats and element arrangements. The inclusion of Assembly Keys (118) provides both functional reinforcement and optional user interaction, supporting customizable, visually distinctive assemblies across diverse use cases.

### Manufacturing and Materials

Components of the MCWA system, including Modular Candle Elements (109), Fragrance Elements (114), Assembly Keys (118), Infuser-Compatible Candle (119), and Candle Assembly Foundations (209), may be manufactured using any suitable process for forming components from flammable materials solid at room temperature, such as wax-based compositions, thermoplastics, or other combustible blends. These processes include, but are not limited to, injection molding, CNC machining, pressure forming, hand carving, laser cutting, casting, extrusion, engraving, and additive manufacturing. These methods support both artisanal and industrial-scale production, allowing for scalable output with high dimensional precision and repeatability.

The materials suitable for these components include natural waxes such as soy wax, beeswax, palm wax, coconut wax, bayberry wax, and rapeseed wax; synthetic waxes including paraffin, microcrystalline wax, gel wax, and carnauba wax; as well as stearic acid, tallow, mineral waxes, metallic stearates, thermoplastic elastomer gels, and combinations thereof. These materials may be blended to achieve desired melt points, mechanical stability, fragrance carry capability, or aesthetic effect. Materials may be selected to vary melting temperatures across different components to achieve differential melt behavior, fragrance release timing, or handling durability. Other materials may also be employed, provided they exhibit properties suitable for molding, combustion, or aesthetic integration within candle assemblies.

Candle Assembly Foundations (209) may be manufactured from wax-based or non-wax-based materials, including those previously disclosed for use in other components of the MCWA system. Suitable materials may include natural or synthetic waxes, thermoplastic or elastomeric compounds, wood, stone, glass, ceramics, polymers, metals, or composite substrates. Manufacturing techniques may encompass molding, machining, casting, additive manufacturing, or other processes appropriate to the selected material. Foundations may be dimensioned to conform to the shape and footprint of a Modular Candle Element (109) array and may optionally include recesses, channels, cavities, or protrusions to assist in precise positioning and structural retention during assembly, transport, or display.

All components may optionally be enhanced with embedded additives, including pigments, glitter, luminescent materials, thermochromic compounds, encapsulated fragrance microbeads, botanical inclusions (e.g., dried herbs or flowers), metallic foils, embedded logos, shaped inlays, ornamental embedded objects such as gemstones, charms, coins, or themed inserts, or embedded promotional or value-bearing components such as precious metals, jewelry, currency tokens, or concealed inserts configured to support marketing, collectible use, or product differentiation. In particular, the Fragrance Elements (114) and Assembly Keys (118) may be formed from materials designed to melt simultaneously with or at a differential rate compared to the adjacent Modular Candle Elements (109), depending on the intended use case. Fragrance Elements (114) may be formulated to deliver fragrance independently or in coordination with the candle melt cycle, and may incorporate branding, logos, or symbolic content to identify fragrance type, product line, or thematic collection. Assembly Keys (118) may optionally include visual enhancements or embedded branding without altering their primary structural function. Additional enhancements may include magnetic elements, scannable or informational tags (e.g., QR codes, NFC), or other embedded features configured to augment user interaction, product traceability, or system customization.

Kits may include any combination of Modular Candle Elements (109), Fragrance Elements (114), Assembly Keys (118), Candle Assembly Foundations (209), Infuser-Compatible Candles (119), container elements (e.g., glass jars or metal tins), and instructionals or design templates. These kits may be configured for single-use, refillable, or reconfigurable designs and may support educational, artistic, therapeutic, or seasonal use cases.

### Closing Language

As used herein, terms such as “preferably,” “typically,” “generally,” and “in some embodiments” denote non-limiting examples provided for illustrative purposes only. Similarly, modifiers such as “approximately,” “substantially,” and “at least” are intended to encompass tolerances, expected functional deviations, and equivalents recognized by those skilled in the art.

The invention is not limited to the specific embodiments, materials, geometries, or sequences described or depicted. All structural, functional, and material variations that achieve substantially the same result in substantially the same way are intended to fall within the scope of the appended claims. Figures, directional indicators, and individual feature labels are illustrative only and shall be interpreted in a manner consistent with the disclosure as a whole. Each figure and structural feature referenced herein is incorporated by reference, to the extent not inconsistent with the claims.

What is claimed is:

1. A Modular Candle assembly comprising:
(a) a plurality of Modular Candle Elements formed of a flammable material, solid at room temperature, each Modular Candle Element defining an outer geometry and a top-facing burn surface;
(b) wherein at least some of the Modular Candle Elements include at least one structural feature selected from the group consisting of:
(i) a mating or abutting geometry configured to engage with an adjacent Modular Candle Element; and
(ii) an Assembly Key Cavity configured to receive a structural support component;
(c) at least one cavity defined within at least one Modular Candle Element and configured to receive an elongated solid Fragrance Element, the cavity extending from a location proximate to a wick disposed within or adjacent to the Modular Candle assembly and terminating within a Thermal Active Zone of the Modular Candle assembly;
(d) an elongated solid Fragrance Element positioned within the cavity, the Fragrance Element comprising a combustible material, solid at room temperature, and infused with fragrance; and
(e) wherein the elongated Fragrance Element is configured to begin releasing a perceptible fragrance within one minute of wick ignition under standard ambient conditions.

2. The Modular Candle assembly of claim 1, wherein at least two Modular Candle Elements include cavities positioned at different radial or vertical distances from the wick, each cavity configured to receive a Fragrance Element that begins releasing fragrance at a temporally staggered interval during combustion.

3. The Modular Candle assembly of claim 1, wherein the Modular Candle Elements are positioned within a container having an internal diameter greater than that of the assembled structure, the container being configured to laterally constrain the Modular Candle Elements during combustion.

4. The Modular Candle assembly of claim 1, wherein the Modular Candle Elements are configured to assemble into a predefined three-dimensional geometric or symbolic shape selected from the group consisting of: a cylinder, polygon, star, heart, snowflake, pumpkin, tree, or other seasonally themed or ornamental structure.

5. The Modular Candle assembly of claim 1, wherein one or more of the Modular Candle Elements optionally includes a visual or structural enhancement including, without limitation, decorative, branding, or collectible features formed from natural, synthetic, or composite materials, which may be embedded, exposed, or revealed during combustion.

6. The Modular Candle assembly of claim 1, wherein at least one Modular Candle Element includes an embedded identifier selected from a QR code, RFID tag, magnetic signature, or machine-readable optical pattern.

7. A Modular Candle assembly comprising:
(a) a plurality of Modular Candle Elements formed of a flammable material, solid at room temperature, each Modular Candle Element defining an outer geometry and a top-facing burn surface;
(b) wherein at least some of the Modular Candle Elements include at least one structural feature selected from the group consisting of:
(i) a mating or abutting geometry configured to engage with an adjacent Modular Candle Element; and
(ii) an Assembly Key Cavity configured to receive a structural support component;
(c) at least one cavity defined within at least one Modular Candle Element, the cavity being configured to receive a Fragrance Element but optionally remaining unfilled in some embodiments, the cavity extending from a location proximate to a wick and terminating within a Thermal Active Zone of the Modular Candle Element.

8. The Modular Candle assembly of claim 7, wherein at least two Modular Candle Elements include cavities positioned at different radial or vertical distances from the wick, each cavity configured to receive a Fragrance Element that begins releasing fragrance at a temporally staggered interval during combustion.

9. The Modular Candle assembly of claim 7, wherein the Modular Candle Elements are positioned within a container having an internal diameter greater than that of the assembled structure, the container being configured to laterally constrain the Modular Candle Elements during combustion.

10. The Modular Candle assembly of claim 7, wherein at least one of the Modular Candle Elements is composed of a flammable material, solid at room temperature, having fragrance uniformly or non-uniformly distributed throughout its bulk material.

11. The Modular Candle assembly of claim 7, wherein the Modular Candle Elements are configured to assemble into a predefined three-dimensional geometric or symbolic shape selected from the group consisting of: a cylinder, polygon, star, heart, snowflake, pumpkin, tree, or other seasonally themed or ornamental structure.

12. The Modular Candle assembly of claim 7, wherein one or more of the Modular Candle Elements optionally includes a visual or structural enhancement including, without limitation, decorative, branding, or collectible features formed from natural, synthetic, or composite materials, which may be embedded, exposed, or revealed during combustion.

13. The Modular Candle assembly of claim 7, wherein at least one Modular Candle Element includes an embedded identifier selected from a QR code, RFID tag, magnetic signature, or machine-readable optical pattern.

14. A Modular Candle assembly comprising:
(a) a plurality of Modular Candle Elements formed of a flammable material, solid at room temperature, each Modular Candle Element defining an outer geometry and a top-facing burn surface; and
(b) a structural retention configuration retaining the Modular Candle Elements in assembled configuration, the structural retention configuration selected from the group consisting of:
(i) complementary perimeter profiles;
(ii) mating features;
(iii) frictional engagement;
(iv) magnetic elements;
(v) adhesives;
(vi) mechanical fasteners; and
(vii) external containers configured to constrain movement of two or more Modular Candle Elements.

15. The Modular Candle assembly of claim 14, wherein the Modular Candle Elements are positioned within a container having an internal diameter greater than that of the assembled structure, the container being configured to laterally constrain the Modular Candle Elements during combustion.

16. The Modular Candle assembly of claim 14, wherein at least one of the Modular Candle Elements is composed of a flammable material, solid at room temperature, having fragrance uniformly or non-uniformly distributed throughout its bulk material.

17. The Modular Candle assembly of claim 14, wherein the Modular Candle Elements are configured to assemble into a predefined three-dimensional geometric or symbolic shape selected from the group consisting of: a cylinder, polygon, star, heart, snowflake, pumpkin, tree, or other seasonally themed or ornamental structure.

18. The Modular Candle assembly of claim 14, wherein one or more of the Modular Candle Elements optionally includes a visual or structural enhancement including, without limitation, decorative, branding, or collectible features formed from natural, synthetic, or composite materials, which may be embedded, exposed, or revealed during combustion.

19. The Modular Candle assembly of claim 14, wherein at least one Modular Candle Element includes an embedded identifier selected from a QR code, RFID tag, magnetic signature, or machine-readable optical pattern.

20. A Modular Candle assembly comprising:
(a) a plurality of Modular Candle Elements formed of a flammable material, solid at room temperature, each Modular Candle Element defining an outer geometry and a top-facing burn surface; and
(b) wherein at least some of the Modular Candle Elements include at least one structural feature selected from the group consisting of:
(i) a mating or abutting geometry configured to engage with an adjacent Modular Candle Element; and
(ii) an Assembly Key Cavity configured to receive a structural support component.

21. The Modular Candle assembly of claim 20, wherein the Modular Candle Elements are positioned within a container having an internal diameter greater than that of the assembled structure, the container being configured to laterally constrain the Modular Candle Elements during combustion.

22. The Modular Candle assembly of claim 20, wherein at least one of the Modular Candle Elements is composed of a flammable material, solid at room temperature, having fragrance uniformly or non-uniformly distributed throughout its bulk material.

23. The Modular Candle assembly of claim 20, wherein the Modular Candle Elements are configured to assemble into a predefined three-dimensional geometric or symbolic shape selected from the group consisting of: a cylinder, polygon, star, heart, snowflake, pumpkin, tree, or other seasonally themed or ornamental structure.

24. The Modular Candle assembly of claim 20, wherein one or more of the Modular Candle Elements optionally includes a visual or structural enhancement including, without limitation, decorative, branding, or collectible features formed from natural, synthetic, or composite materials, which may be embedded, exposed, or revealed during combustion.

25. The Modular Candle assembly of claim 20, wherein at least one Modular Candle Element includes an embedded identifier selected from a QR code, RFID tag, magnetic signature, or machine-readable optical pattern.

26. A Modular Candle assembly comprising:
(a) a plurality of Modular Candle Elements formed of a combustible material, solid at room temperature, each Modular Candle Element defining an outer geometry and a top-facing burn surface;
(b) the plurality of Modular Candle Elements being configured to interlock or mate with one another to form a unified three-dimensional candle structure;
(c) wherein none of the Modular Candle Elements defines a cavity configured to receive a Fragrance Element; and
(d) wherein at least one of the Modular Candle Elements optionally includes one or more enhancements selected from the group consisting of:
(i) embedded decorative or thematic objects;
(ii) glitter, pigments, or luminescent additives;
(iii) thermochromic compounds responsive to heat;
(iv) molded or engraved branding; and
(v) embedded decorative, collectible, or promotional items positioned to be revealed during combustion, the items comprising gemstones, charms, foils, metallic inserts, or other formed objects configured for visual exposure or retrieval.

27. The Modular Candle assembly of claim 26, wherein the Modular Candle Elements are positioned within a container having an internal diameter greater than that of the assembled structure, the container being configured to laterally constrain the Modular Candle Elements during combustion.

28. The Modular Candle assembly of claim 26, wherein the Modular Candle Elements are configured to assemble into a predefined three-dimensional geometric or symbolic shape selected from the group consisting of: a cylinder, polygon, star, heart, snowflake, pumpkin, tree, or other seasonally themed or ornamental structure.

29. The Modular Candle assembly of claim 26, wherein at least one Modular Candle Element includes an embedded identifier selected from a QR code, RFID tag, magnetic signature, or machine-readable optical pattern.

30. A Non-Modular Candle comprising:
(a) a candle body formed of a flammable material, solid at room temperature and defining an outer geometry and a top-facing burn surface;
(b) at least one wick disposed within the candle body; and
(c) at least one cavity defined within the candle body, the cavity configured to receive an elongated solid Fragrance Element and extending into a Thermal Active Zone of the candle body such that the Fragrance Element begins releasing a perceptible fragrance within one minute of wick ignition under standard ambient conditions.

31. The Non-Modular Candle of claim 30, wherein the container includes one or more integrated cavities, grooves, or recesses configured to receive Fragrance Elements in a fixed position relative to the candle body.

32. The Non-Modular Candle of claim 30, wherein none of the cavities defined within the candle body are occupied by a Fragrance Element.

33. The Non-Modular Candle of claim 30, wherein at least two Fragrance Elements are disposed within separate cavities positioned at different radial or vertical depths within the candle body, such that the Fragrance Elements begin releasing different fragrances at temporally staggered intervals during combustion.

34. The Non-Modular Candle of claim 30, wherein the candle body is positioned within a container having an internal diameter greater than that of the candle body, such that the container laterally constrains the candle body during combustion.

35. The Non-Modular Candle of claim 30, wherein the candle body optionally includes a visual or structural enhancement including, without limitation, decorative, branding, or collectible features formed from natural, synthetic, or composite materials, which may be embedded, exposed, or revealed during combustion.

36. The Non-Modular Candle of claim 30, wherein the candle body includes an embedded identifier selected from a QR code, RFID tag, magnetic signature, or machine-readable optical pattern.

37. A Non-Modular Candle comprising:
(a) a candle body formed of a flammable material, solid at room temperature and defining a top-facing burn surface and at least one sidewall;
(b) at least one cavity defined within the candle body, the cavity configured to receive an elongated solid Fragrance Element and extending into a Thermal Active Zone of the candle body such that, during combustion, the Fragrance Element begins releasing a perceptible fragrance within one minute of wick ignition under standard ambient conditions;
(c) at least one elongated solid Fragrance Element disposed within the cavity, the Fragrance Element composed of a combustible material, solid at room temperature, and infused with fragrance; and
(e) wherein the candle is optionally housed within a container composed of glass, ceramic, stone, metal, or polymer, the container configured to maintain structural integrity during combustion.

38. The Non-Modular Candle of claim 37, wherein the container includes one or more integrated cavities, grooves, or recesses configured to receive Fragrance Elements in a fixed position relative to the candle body.

39. The Non-Modular Candle of claim 37, wherein at least two Fragrance Elements are disposed within separate cavities positioned at different radial or vertical depths within the candle body, such that the Fragrance Elements begin releasing different fragrances at temporally staggered intervals during combustion.

40. The Non-Modular Candle of claim 37, wherein the candle body is positioned within a container having an internal diameter greater than that of the candle body, such that the container laterally constrains the candle body during combustion.

41. The Non-Modular Candle of claim 37, wherein the candle body optionally includes a visual or structural enhancement including, without limitation, decorative, branding, or collectible features formed from natural, synthetic, or composite materials, which may be embedded, exposed, or revealed during combustion.

42. The Non-Modular Candle of claim 37, wherein the candle body includes an embedded identifier selected from a QR code, RFID tag, magnetic signature, or machine-readable optical pattern.

43. A kit for assembling a customizable Modular Candle, comprising:
(a) a plurality of Modular Candle Elements formed of a flammable material, solid at room temperature, each Modular Candle Element defining an outer geometry and a top-facing burn surface;
(b) at least one wick configured to be disposed within or adjacent to the assembled Modular Candle;
(c) at least one elongated solid Fragrance Element composed of a combustible material, solid at room temperature, and infused with fragrance, and configured for placement within a cavity defined in one or more of the Modular Candle Elements, the cavity extending into a Thermal Active Zone of the assembled Modular Candle;
(d) one or more structural support components or assembly features configured to engage with complementary features of one or more Modular Candle Elements; and
(e) a container configured to receive and laterally constrain the assembled Modular Candle Elements during combustion.

44. The kit of claim 43, wherein the kit comprises only components (a), (b), (c) and (e).

45. The kit of claim 43, wherein at least one of the Modular Candle Elements is composed of a flammable material, solid at room temperature, having fragrance distributed throughout its bulk material, and wherein the Modular Candle Element does not define a cavity configured to receive a Fragrance Element.

46. The kit of claim 43, wherein the Modular Candle Elements are configured to assemble into a predefined three-dimensional geometric or symbolic shape selected from the group consisting of: a cylinder, polygon, star, heart, snowflake, pumpkin, tree, or other seasonally themed or ornamental structure.

47. The kit of claim 43, wherein one or more of the Modular Candle Elements optionally includes a visual or structural enhancement including, without limitation, decorative, branding, or collectible features formed from natural, synthetic, or composite materials, which may be embedded, exposed, or revealed during combustion.

48. The kit of claim 43, wherein at least one Modular Candle Element includes an embedded identifier selected from a QR code, RFID tag, magnetic signature, or machine-readable optical pattern.

49. A kit for assembling a customizable Non-Modular Candle system, comprising:
(a) at least one Non-Modular Candle body formed of a flammable material, solid at room temperature, the candle body defining a top-facing burn surface and at least one cavity extending into a Thermal Active Zone of the candle body;
(b) at least one wick configured to be disposed within the candle body;
(c) at least one elongated solid Fragrance Element composed of a combustible material, solid at room temperature, and infused with fragrance, the Fragrance Element being configured for placement within the cavity of the candle body; and
(d) container or packaging system configured to retain the candle body and the Fragrance Element(s) in a bundled configuration for sale or transport.

50. The kit of claim 49, wherein the kit comprises only components (a), (b), and (d).

51. A Fragrance Element comprising a combustible material, solid at room temperature, and infused with fragrance, the Fragrance Element having an elongated geometry and being dimensioned for insertion into a cavity defined within a candle body, the cavity extending into a Thermally Active Zone of the candle body.

52. A kit comprising a plurality of Fragrance Elements according to claim 51, the Fragrance Elements being packaged together for sale and dimensioned for placement within cavities of modular or Non-Modular Candle bodies.

53. The kit of claim 52, wherein a plurality of the Fragrance Elements are configured to be inserted in series within a single cavity of a candle body to collectively extend into a Thermal Active Zone of the candle body.
